(19) United States
(12) Patent Application Publication
(10) Pub. No.: US 2011/0258041 A1
(43) Pub. Date: Oct. 20, 2011

(54) Method and Apparatus for Landing Page Optimization

(75) Inventors: Serge Ioffe, San Carlos, CA (US); Aleksey Studnev, Zhukovsky (RU)

(73) Assignee: LifeStreet Corporation, San Carlos, CA (US)

(21) Appl. No.: 13/089,258

(22) Filed: Apr. 18, 2011

Related U.S. Application Data
(60) Provisional application No. 61/326,194, filed on Apr. 20, 2010.
(60) Provisional application No. 61/326,177, filed on Apr. 20, 2010.
(60) Provisional application No. 61/326,185, filed on Apr. 20, 2010.
(60) Provisional application No. 61/326,190, filed on Apr. 20, 2010.
(60) Provisional application No. 61/326,196, filed on Apr. 20, 2010.

(51) Int. Cl. G06Q 30/00; G06F 17/30

(52) U.S. Cl. 705/14.46; 707/600; 707/605; 707/E17.141; 707/E17.117

(57) ABSTRACT

A method and apparatus for landing page optimization have been disclosed. In one version offer or landing page optimization occurs by correlating post conversion events based on an identification established at conversion.

### RELATED APPLICATION

The present application for patent is related to U.S. Patent Application No. 61/326,177 entitled “Method and Apparatus for Creative Optimization” filed Apr. 20, 2010, pending, by the same inventors and is hereby incorporated herein by reference. The present application for patent is related to U.S. Patent Application No. 61/326,185 entitled “Method and Apparatus for Inventory Optimization” filed Apr. 20, 2010, pending, by the same inventors and is hereby incorporated herein by reference. The present application for patent is related to U.S. Patent Application No. 61/326,190 entitled “Method and Apparatus for Product Optimization” filed Apr. 20, 2010, pending, by the same inventors and is hereby incorporated herein by reference. The present application for patent is related to U.S. Patent Application No. 61/326,196 entitled “Method and Apparatus for Operational Structure” filed Apr. 20, 2010, pending, by the same inventors and is hereby incorporated herein by reference. The present application for patent is related to U.S. patent application Ser. No. ______ entitled “Method and Apparatus for Creative Optimization” filed Apr. 18, 2011, pending, by the same inventors and is hereby incorporated herein by reference. The present application for patent is related to U.S. patent application Ser. No. ______ entitled “Method and Apparatus for Campaign and Inventory Optimization” filed Apr. 18, 2011, pending, by the same inventors and is hereby incorporated herein by reference. The present application for patent is related to U.S. patent application Ser. No. ______ entitled “Method and Apparatus for Product and Post Conversion Optimization” filed Apr. 18, 2011, pending, by the same inventors and is hereby incorporated herein by reference. The present application for patent is related to U.S. patent application Ser. No. ______ entitled “Method and Apparatus for Universal Placement Server” filed Apr. 18, 2011, pending, by the same inventors and is hereby incorporated herein by reference.

### FIELD OF THE INVENTION

The present invention pertains to advertising. More particularly, the present invention relates to a method and apparatus for landing page optimization.

### BACKGROUND OF THE INVENTION

Advertising is widespread and particularly so on the world wide web (web). Advertisers place an advertisement (ad) or advertisements (ads) to attract users. If these ads are not acted on by the user then they may represent a waste of money and/or resources. This presents a problem.

### BRIEF DESCRIPTION OF THE DRAWINGS

The invention is illustrated by way of example and not limitation in the figures of the accompanying drawings in which:

FIG. 1 illustrates a network environment in which the method and apparatus of the invention may be controlled;

FIG. 2 is a block diagram of a computer system which some embodiments of the invention may employ parts of; and

FIGS. 3-63 illustrate various embodiments of the present invention.

### DETAILED DESCRIPTION

A method and apparatus for landing page optimization is disclosed. Optimization is more “sales” for the same amount of “purchases” or “sales” when a user shows no interest in continuing a purchase or a user exits.

In one embodiment of the invention offer or landing page optimization can occur pre-conversion.

In one embodiment of the invention offer or landing page optimization can occur when a user shows no interest.

In one embodiment of the invention offer or landing page optimization and user interactions are part of a portfolio.

In one embodiment of the invention offer or landing page optimization can occur post-conversion after a user has decided to purchase other than the original offer for which the user showed interest.

In one embodiment of the invention offer or landing page optimization is cross-sell.

In one embodiment of the invention offer or landing page optimization is an up-sell.

In one embodiment of the invention offer or landing page optimization takes into account asynchronous events in time.

In one embodiment of the invention offer or landing page optimization takes into account selling for a longer time period.

In one embodiment of the invention offer or landing page optimization utilizes an identification (ID) established at the time of conversion to correlate temporally separated events.

In one embodiment of the invention, optimizer algorithm results are presented to a user showing a tag, names, engine on which a cube is running, properties, campaigns, auctions, comparison of actual to predicted performance, criteria dropped, etc.

In one embodiment of the invention, slot advisory report results are presented to a user showing a cluster of like behaving things based on a variety of selectable criteria, lists of campaigns, clusters of like behavior, etc.

In one embodiment of the invention, direct marketing analysis (DMA) tool results are presented to a user showing a slot rotation, tag, traffic rules in effect, type of rotation, ad size, relational status (parent, child) of the slot, gender effects, impression counts, rules for behavior, if then else rule sets, etc.

In one embodiment of the invention, direct market (DM) jet results are presented to a user showing slot rotation, campaigns, weights (not %), percentage, location of where a campaign will occur in a slot, drill down information, and a manual approach.

In one embodiment of the invention post conversion events are measured in real time.

In one embodiment of the invention post conversion events are grouped based on a criteria other than real time.

In one embodiment of the invention risk management is key to success. For example if an ad network buys and sells at CPM there is little risk and their value-add is the sales force. Buying at CPM and selling at CPA or Rev Share entails greater risk/reward and value-add is the technology required to optimize and control risk. Profiting from risk requires both Optimization and Stringent Risk Controls. In one embodiment of the present invention, optimization is based on HIGH VELOCITY COMPETITION BETWEEN SUCESSIVE GENERATIONS OF f[x]. Where the functions (f[x]) optimized cut across various planes, for example, Creative/Content Optimization, Inventory Optimization, Product Optimization, and Offer Optimization. In each case we take a given function (a) creative or LP content (b) optimization rule-sets (c) post conversion user experiences and/or (d) pre-conversion or user exit and create multiple variations that we allow to compete in a high velocity environment. All of these are dependant, so we do not optimize ads separately from LPs or from the post-sub emails, etc. . . . we are always optimizing PATHs (not points). Stringent risk control also requires that we “fail quickly/cheaply” therefore Creative testing shuts off as soon as we reach a confidence level (e.g. say 99%) that something is a winner and then we move on to the next generation where the winner is the control. In one embodiment of the invention, Inventory learning takes place in only cheap “representative pockets”, for example, say the 4th-10th frequency only in the Midwest and only for Publisher X, Y and Z who represent average inventory for 3 different types (say games, quizzes and news). If learning is positive, then we scale to more data points before promoting to the scaled optimizer (e.g. learned rules). Likewise, post sales opportunities are combined across different times to create vectors (e.g. the ROI report) that gives us user values that we underwrite to for certain inventory slices. This goes back into the ad-server optimizer as pRPM calculations.

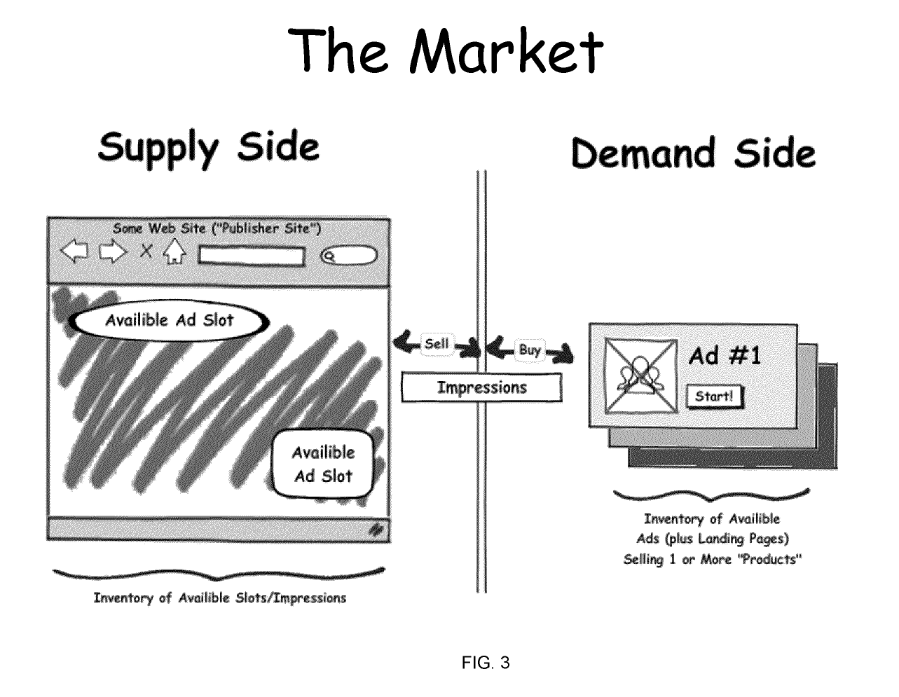

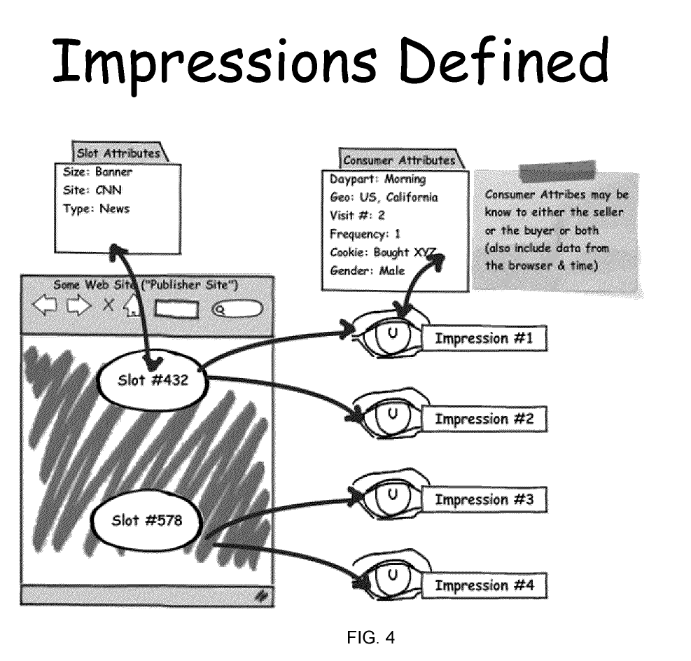

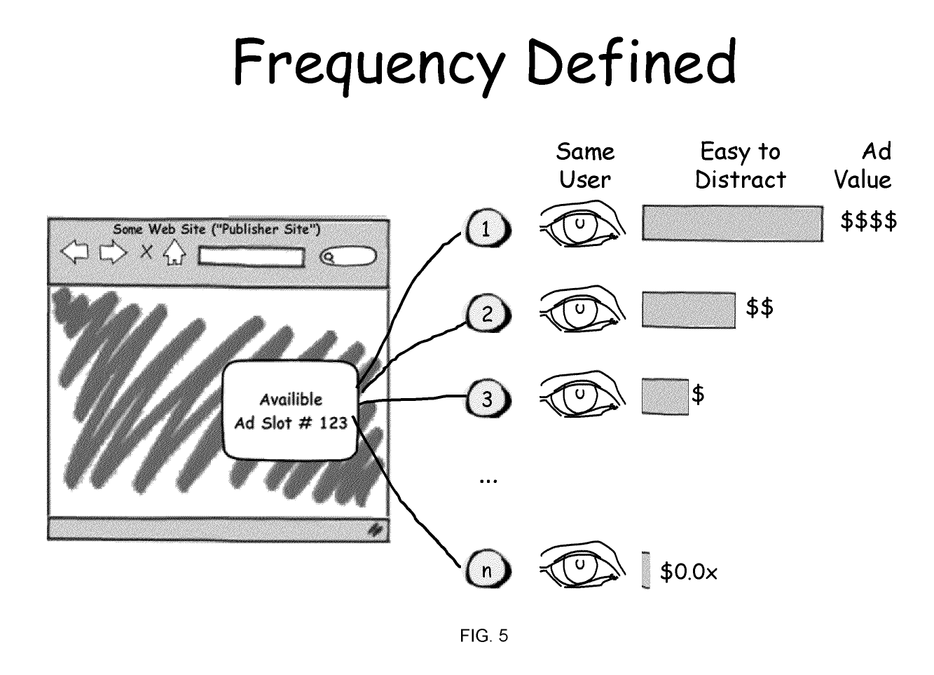

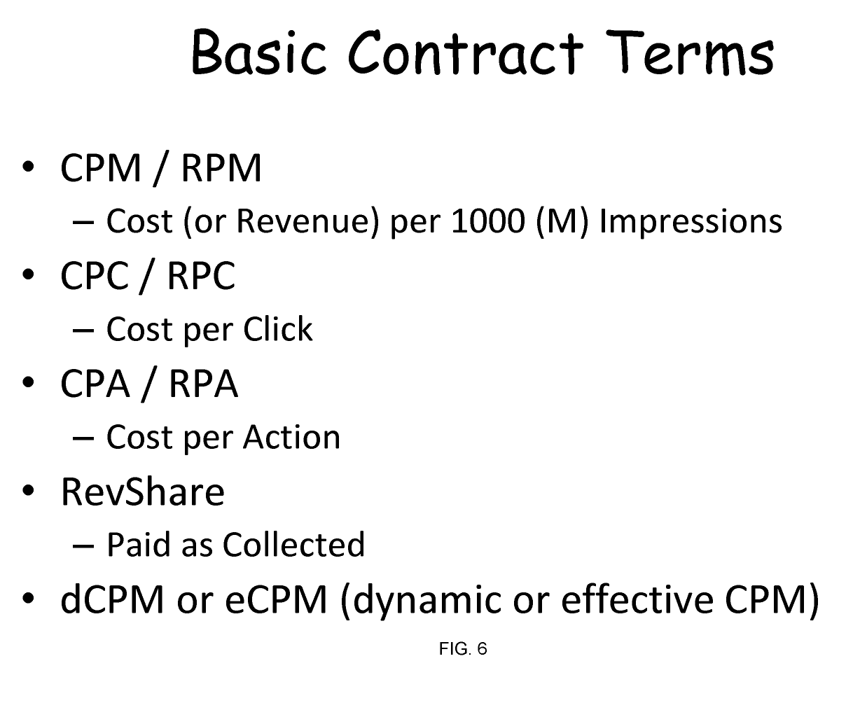

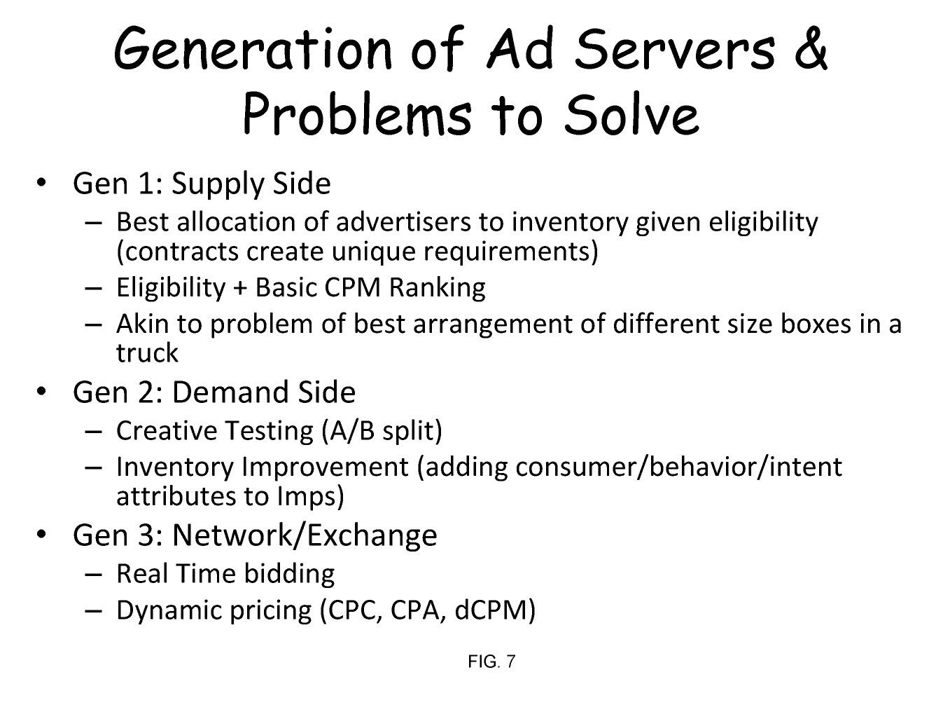

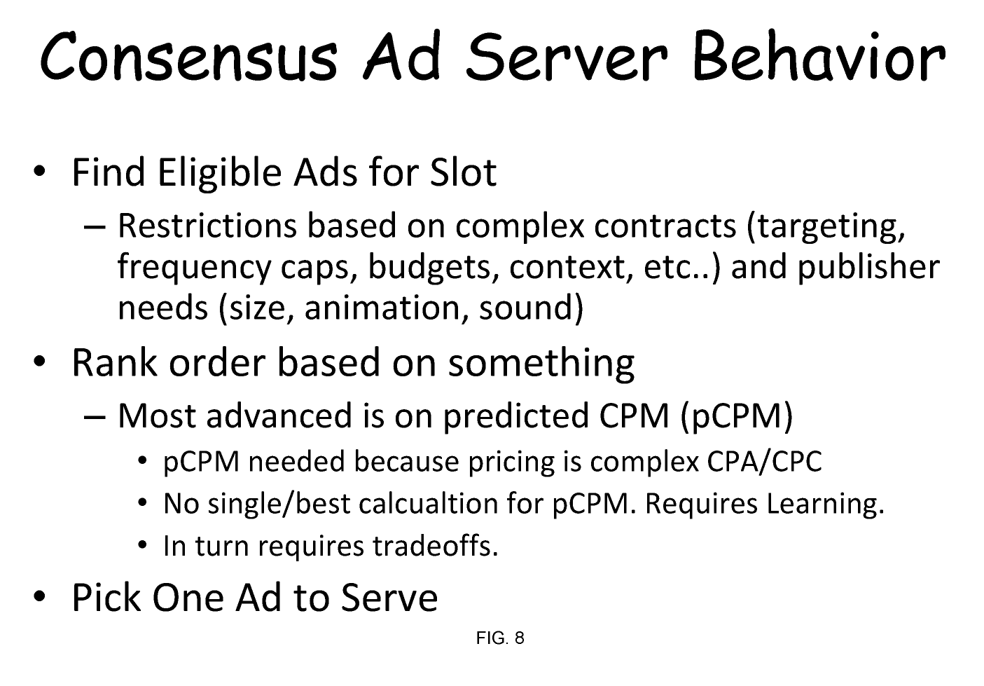

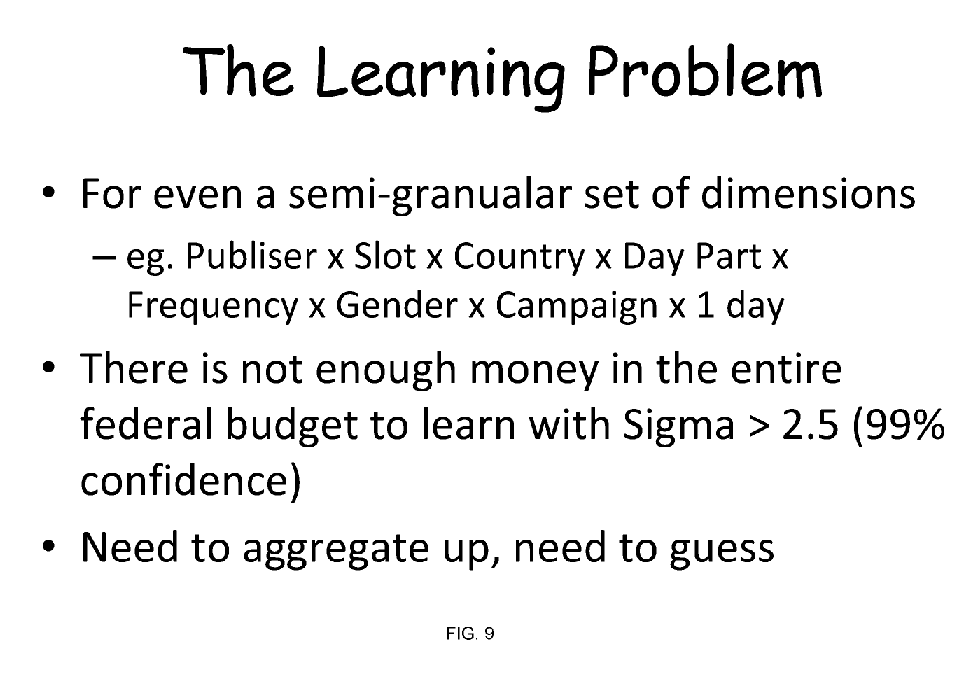

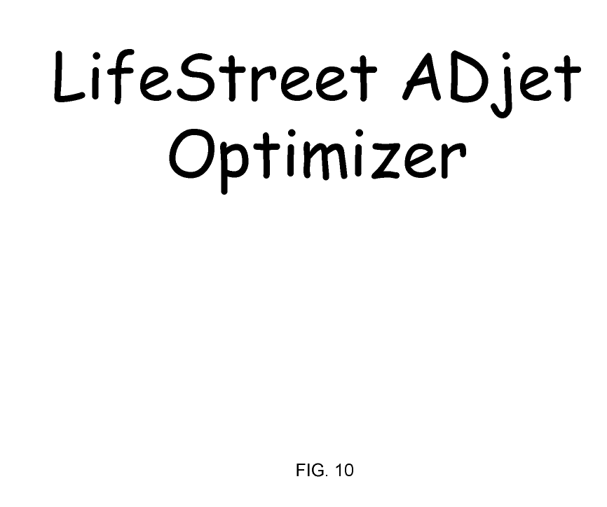

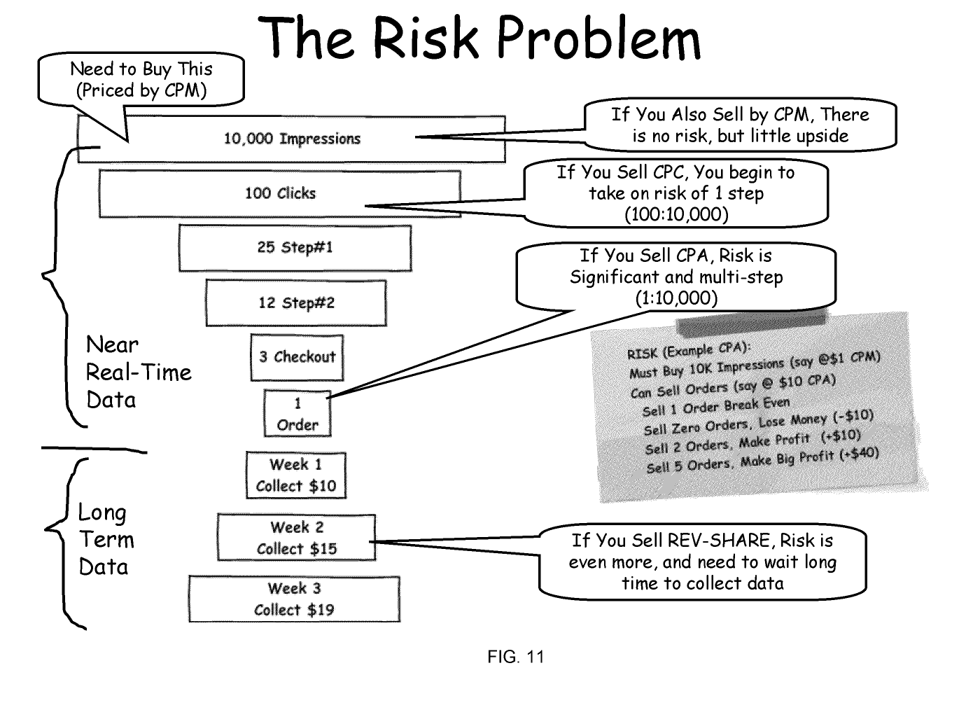

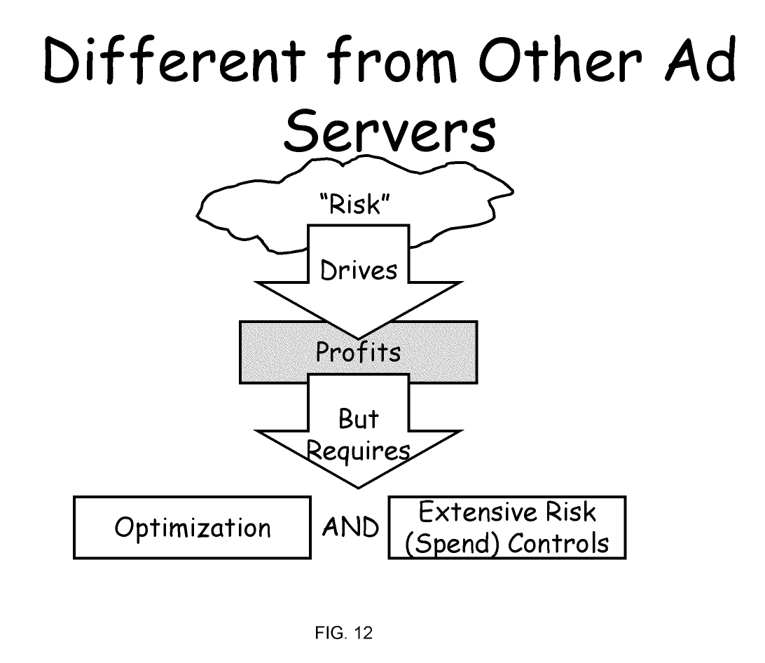

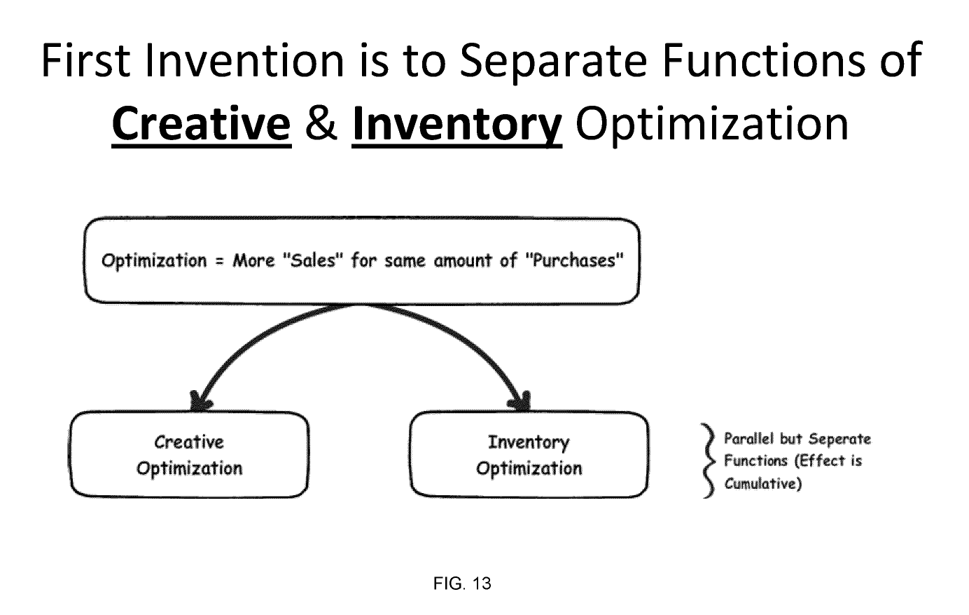

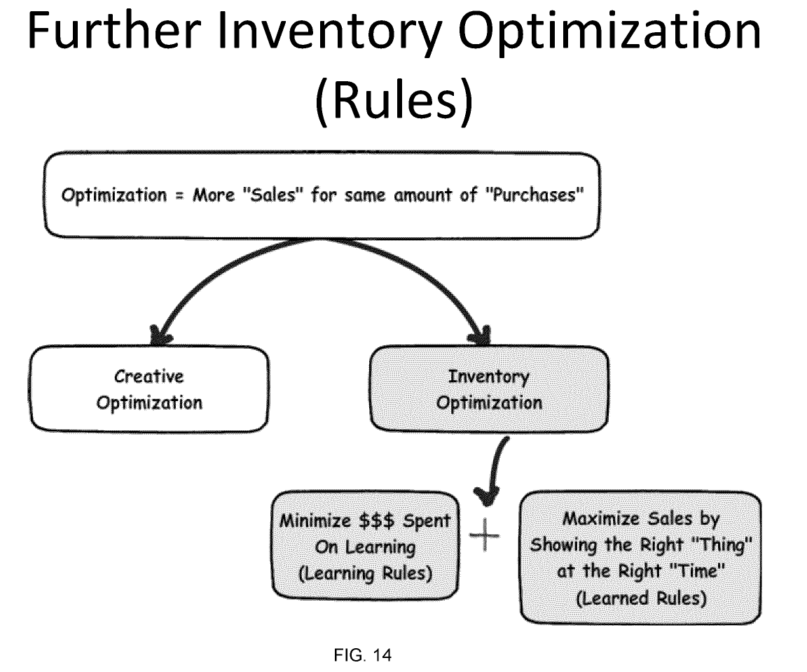

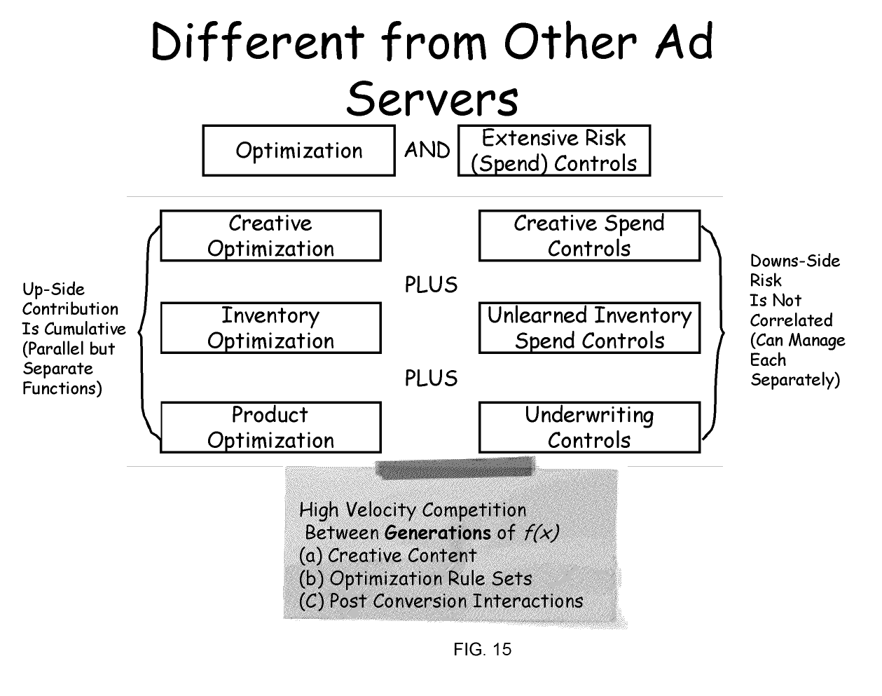

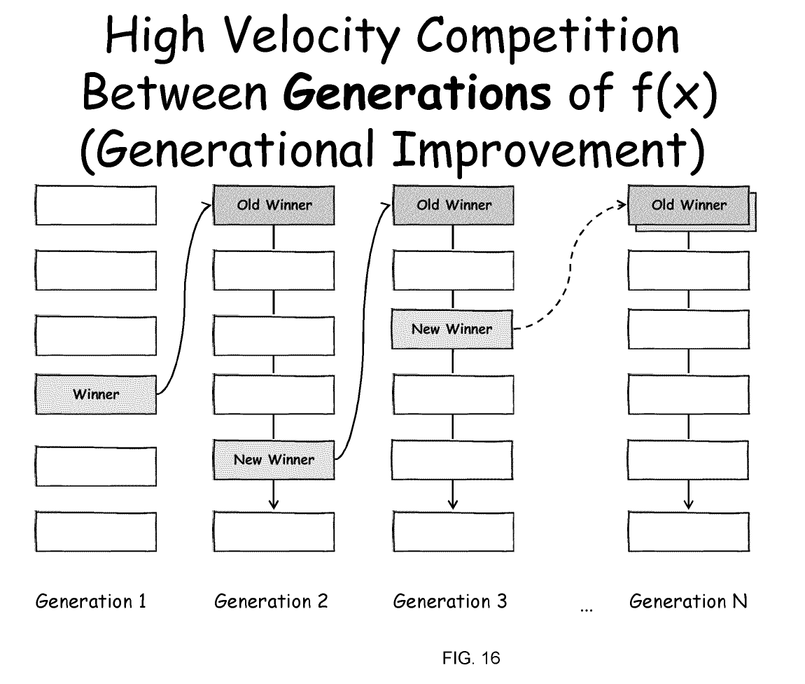

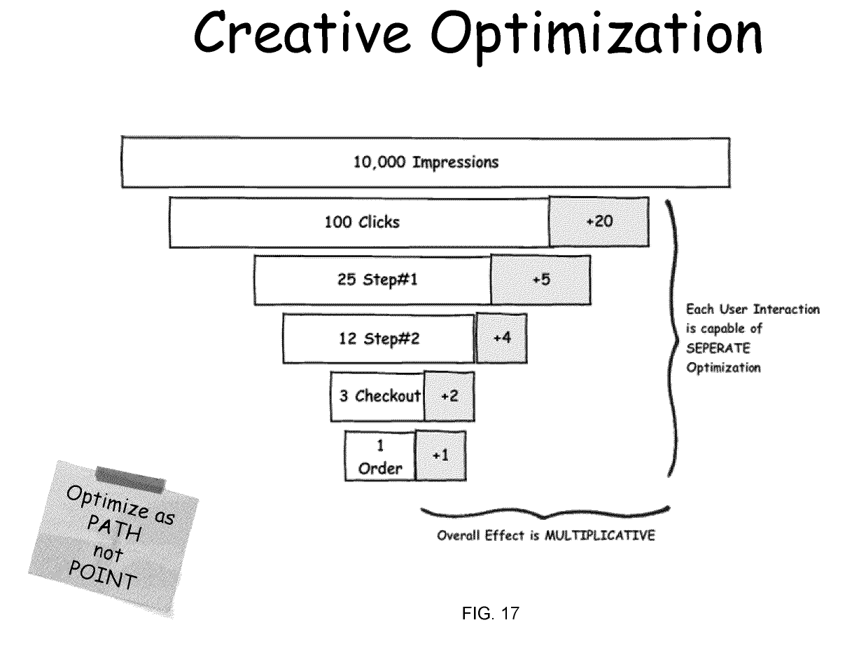

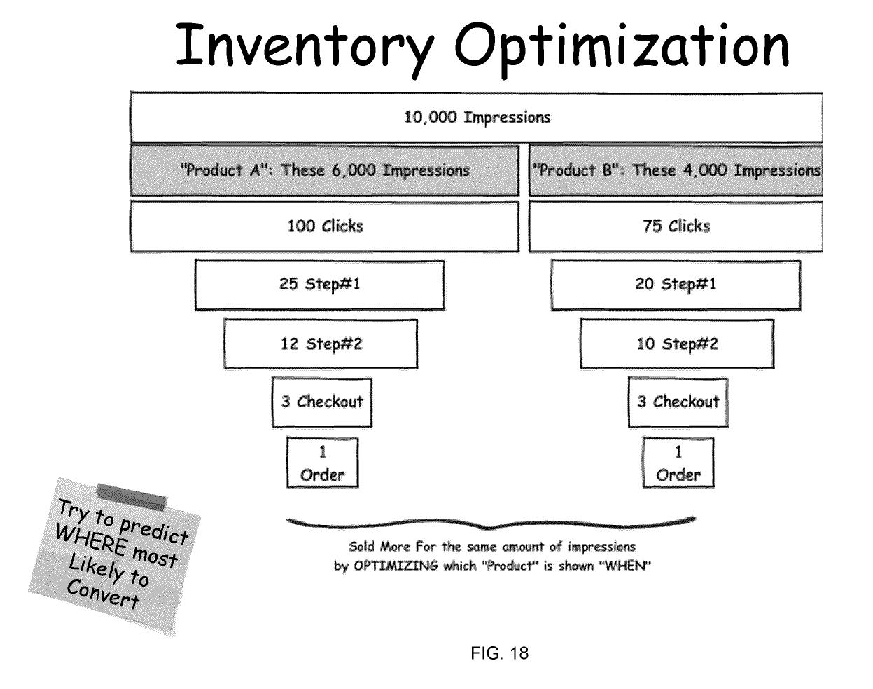

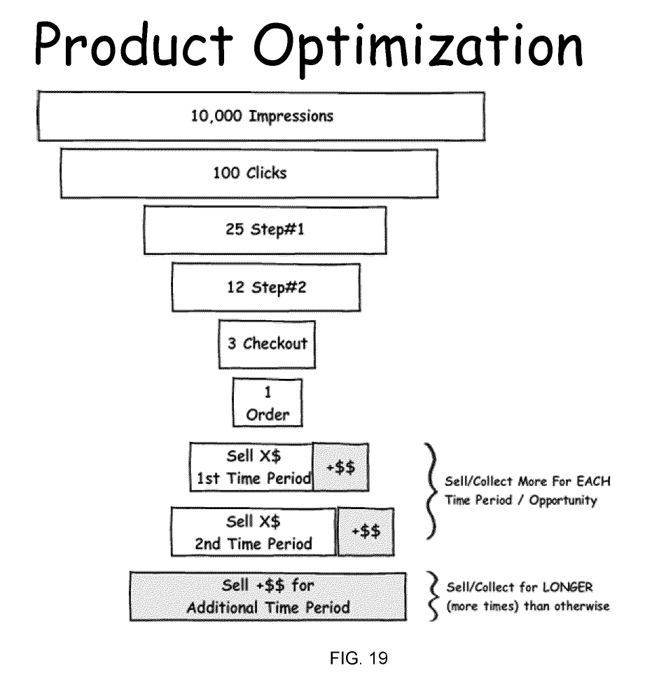

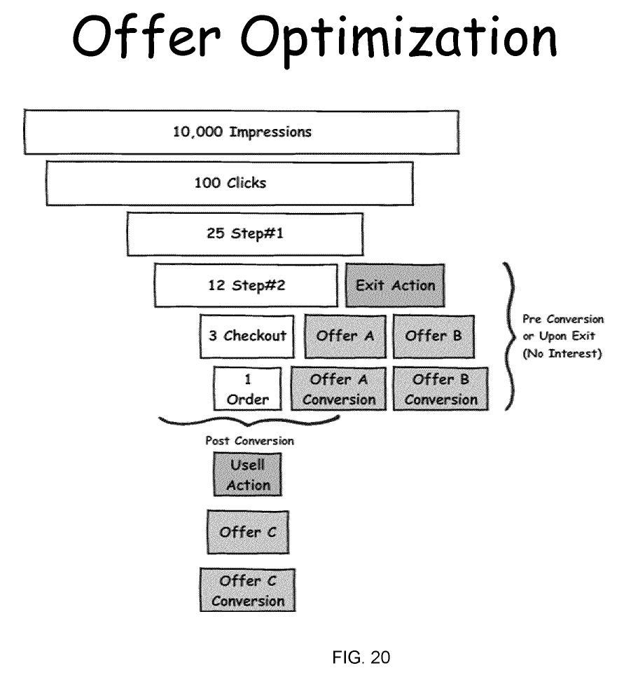

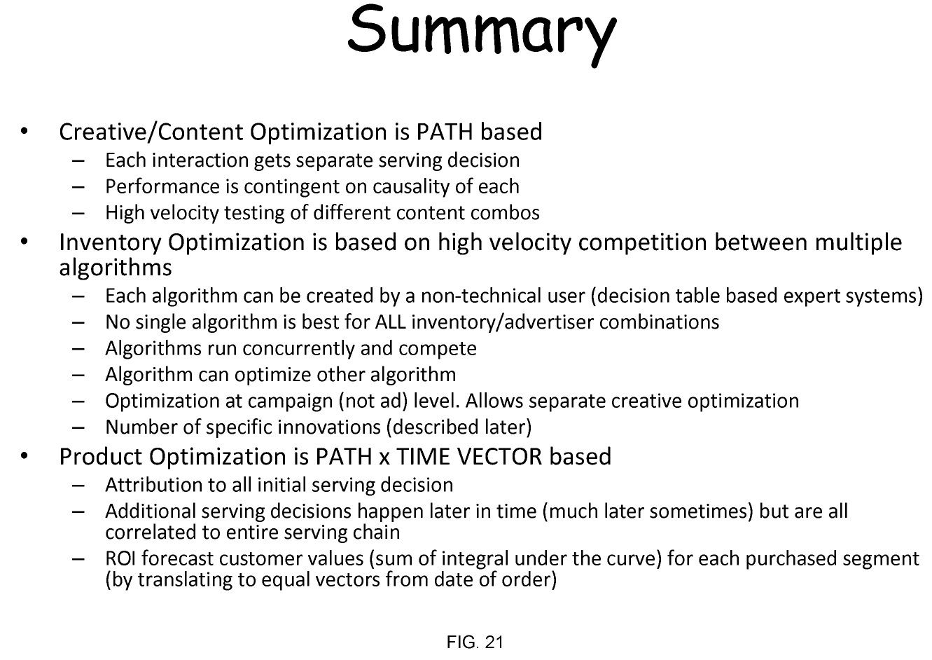

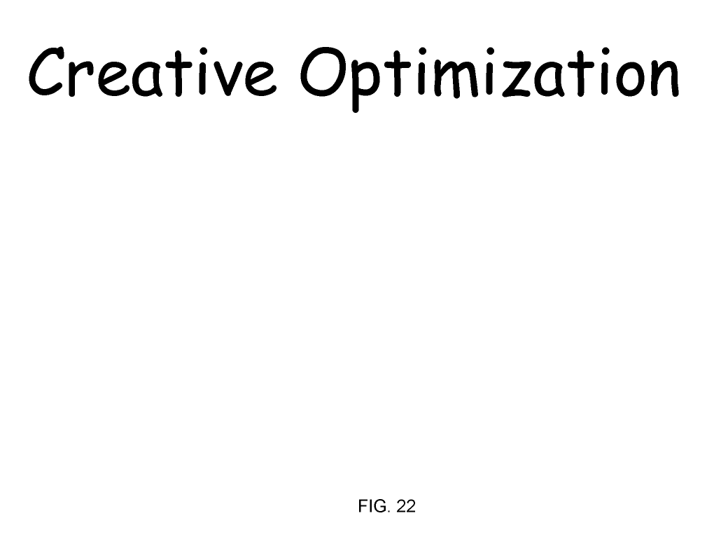

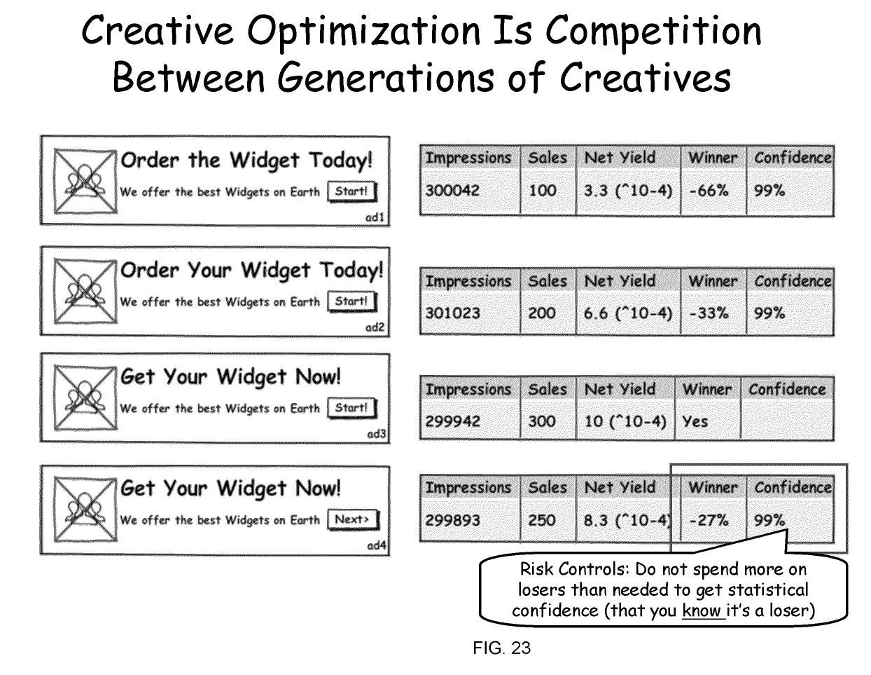

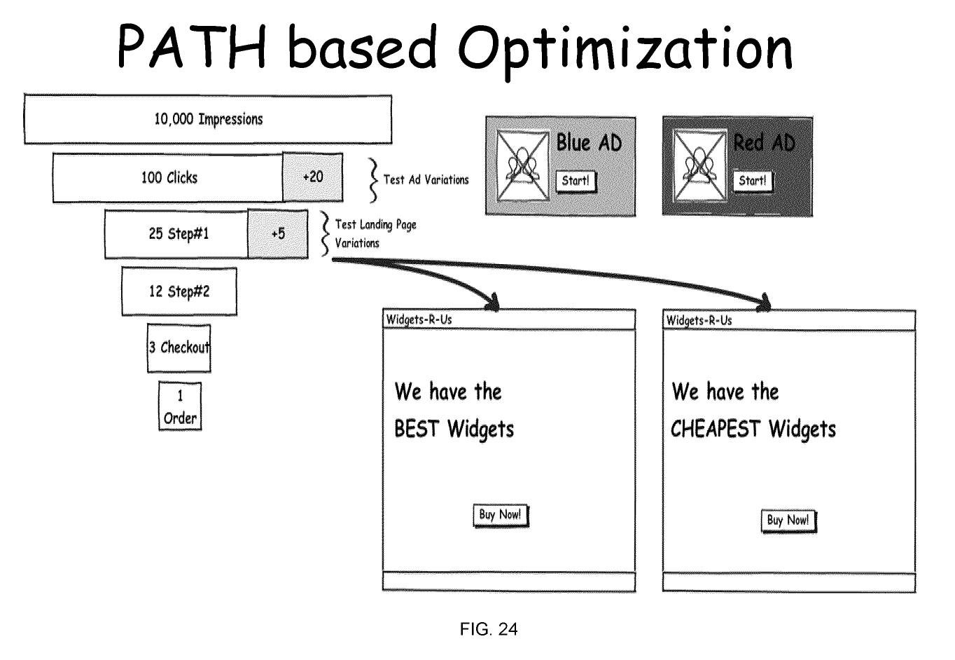

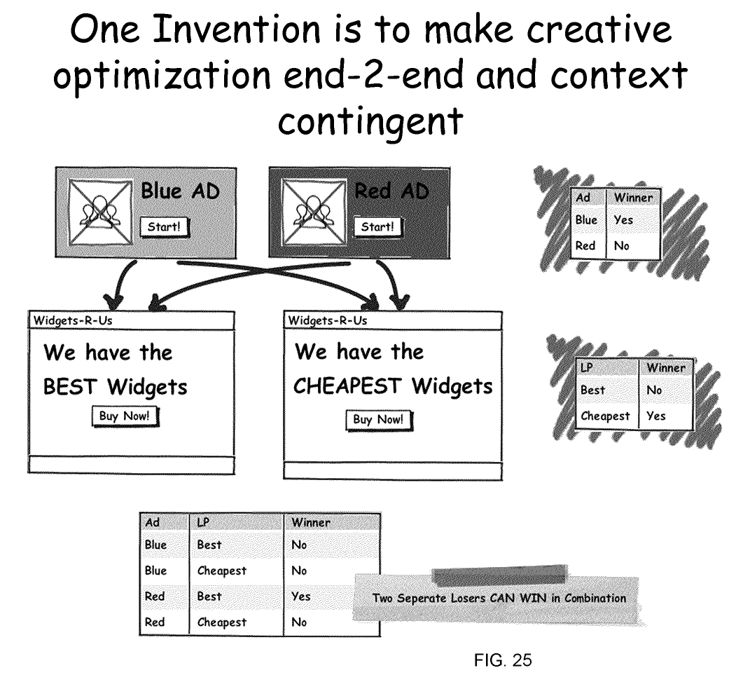

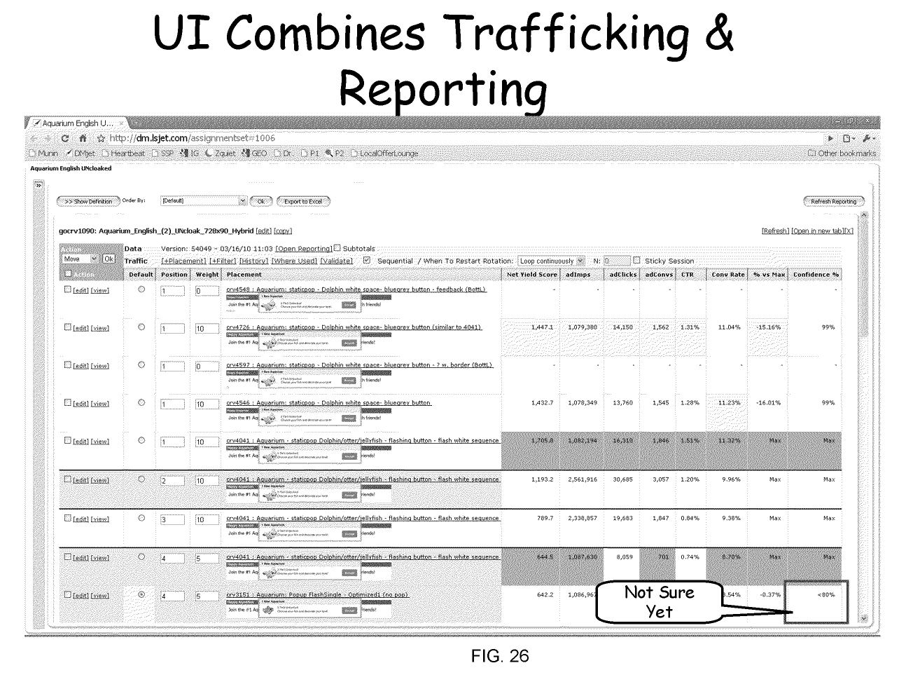

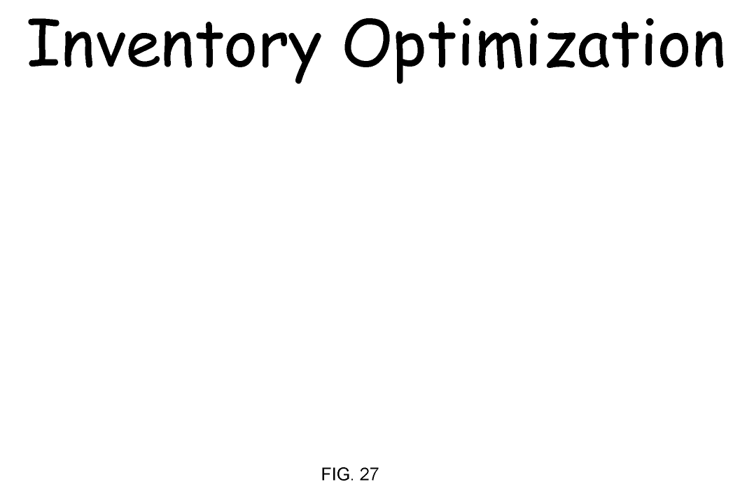

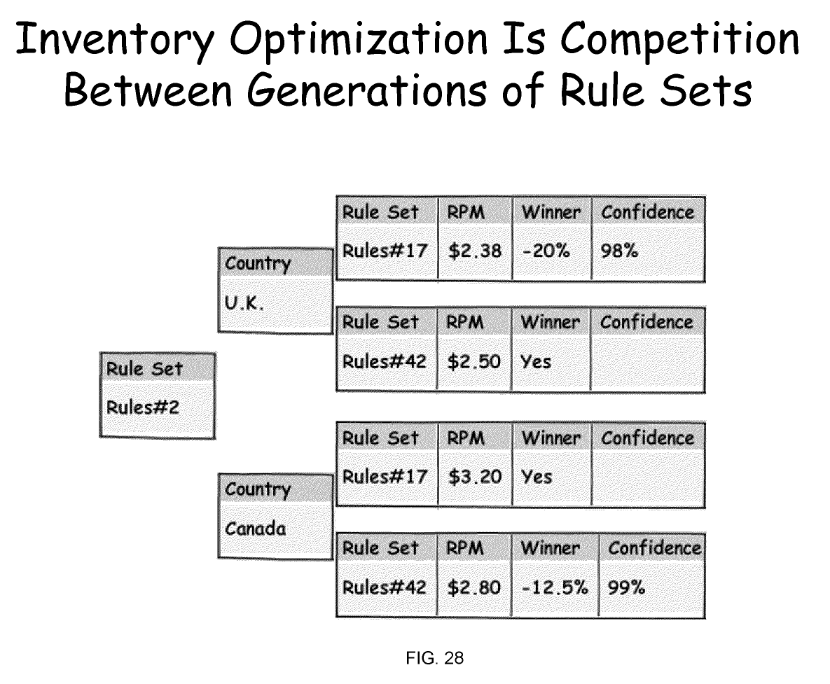

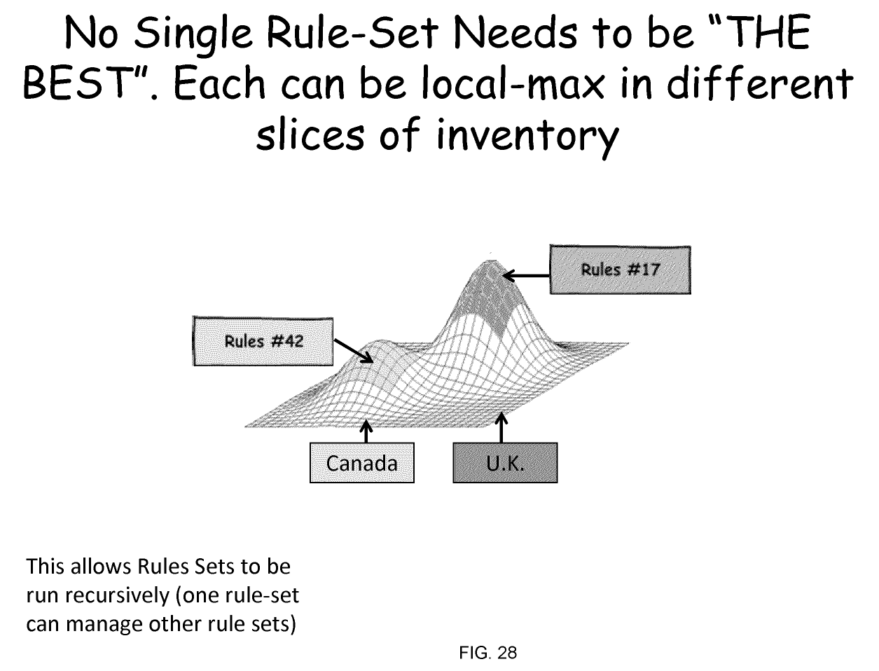

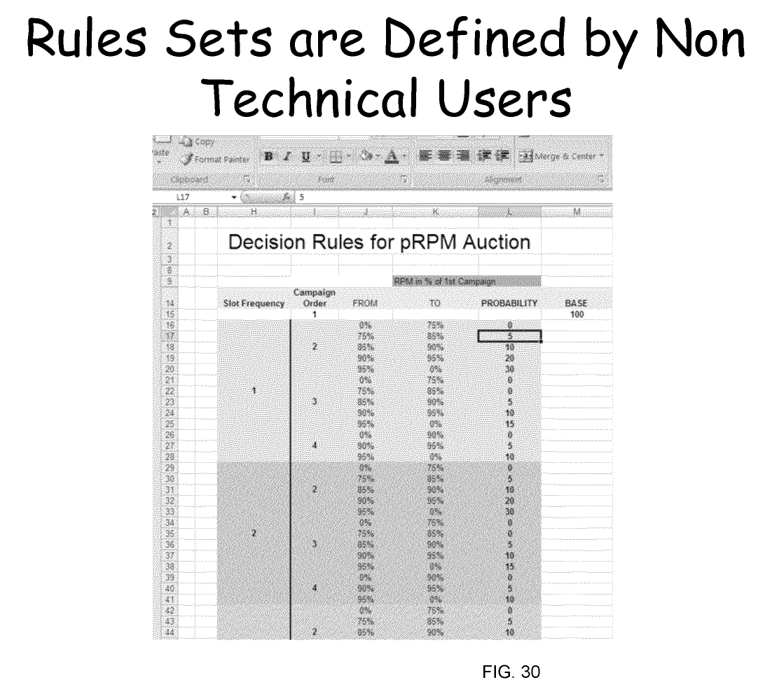

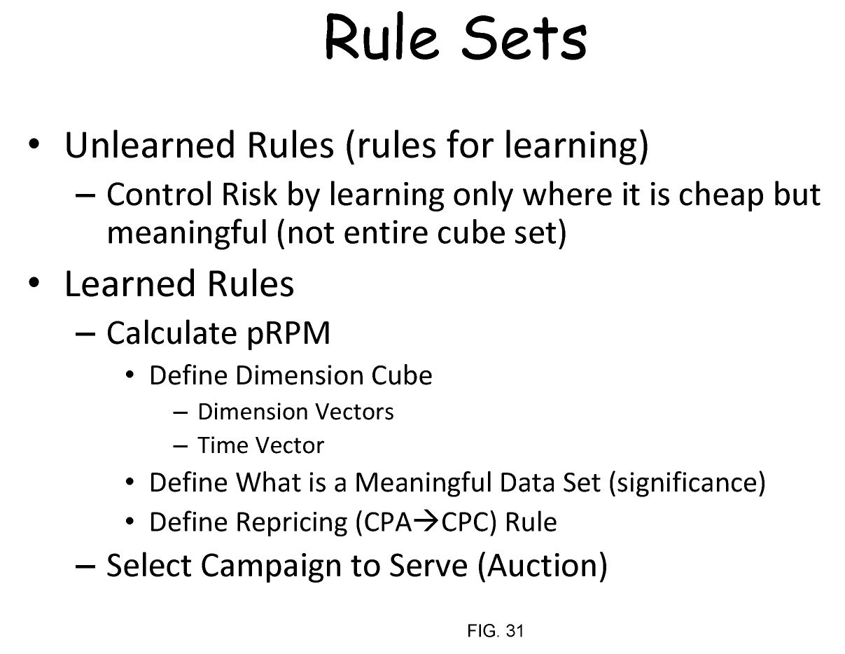

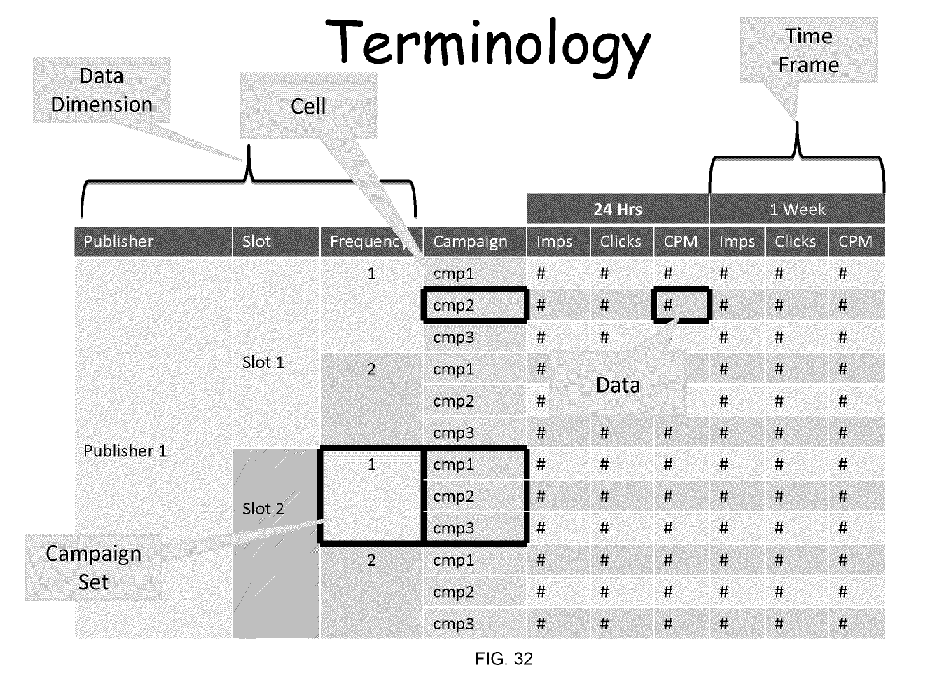

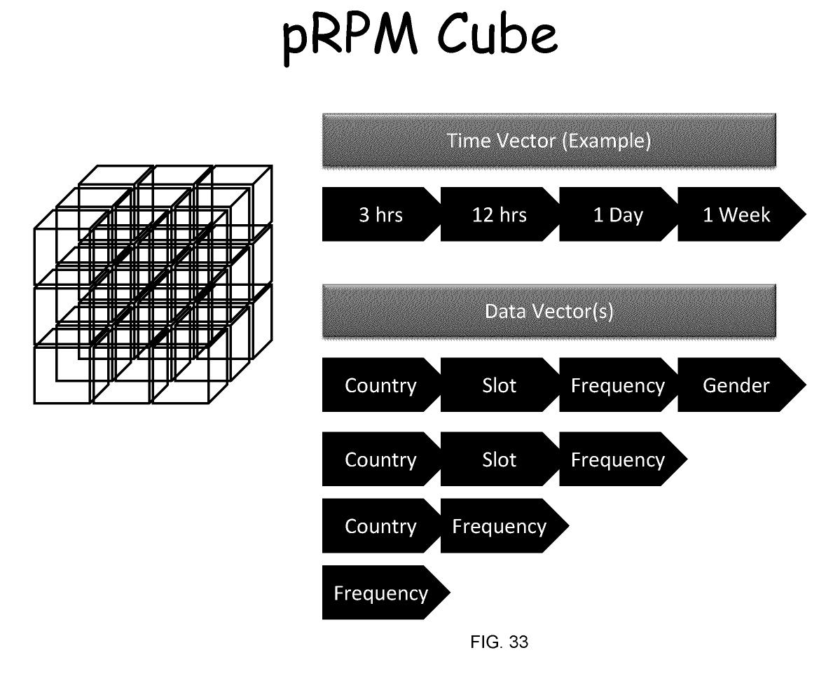

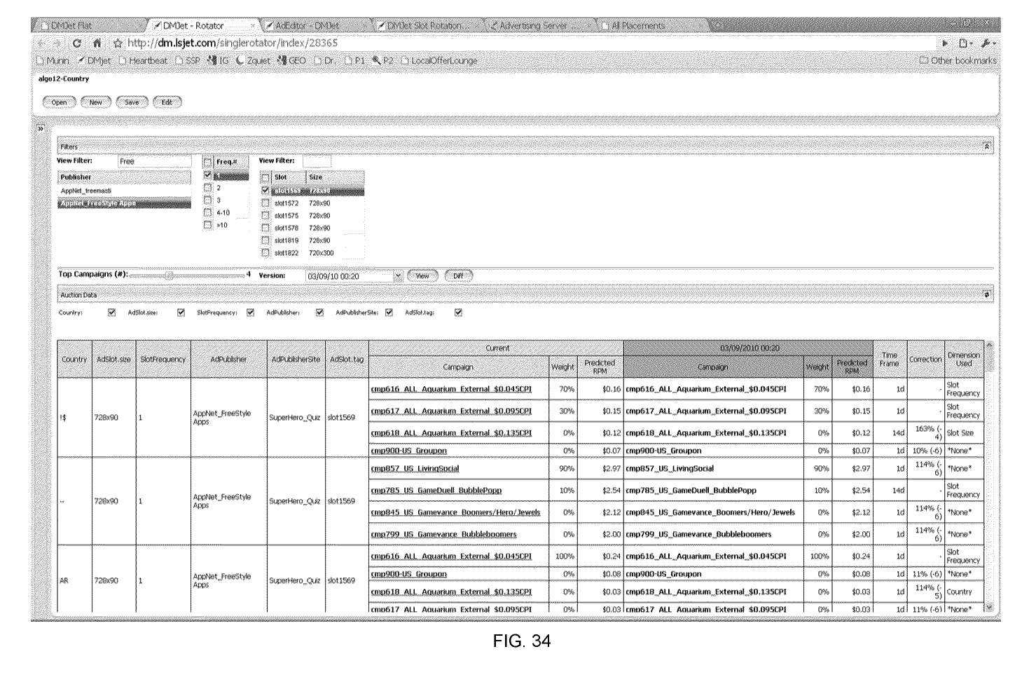

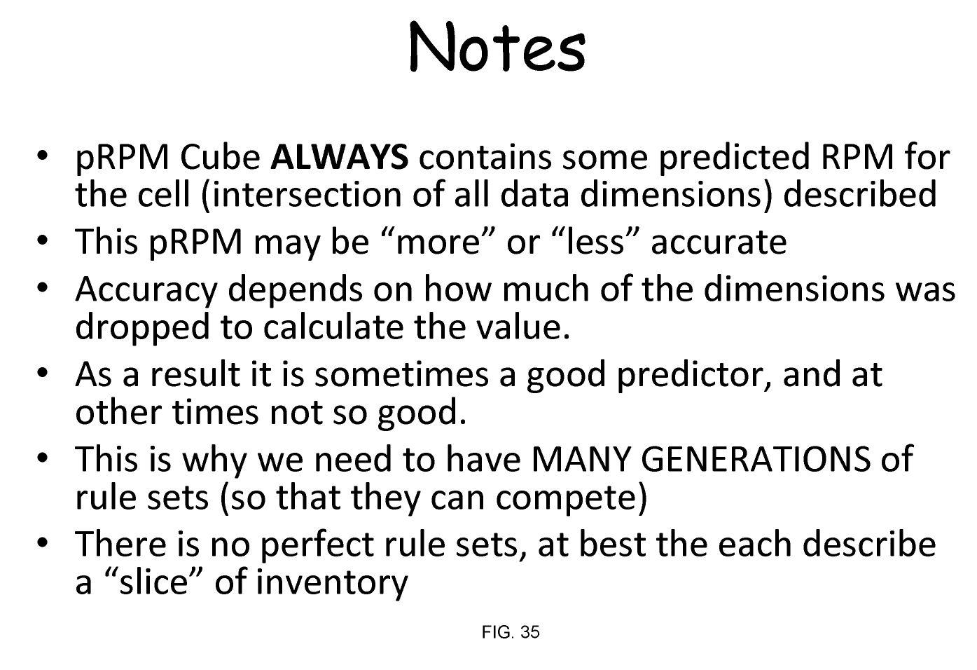

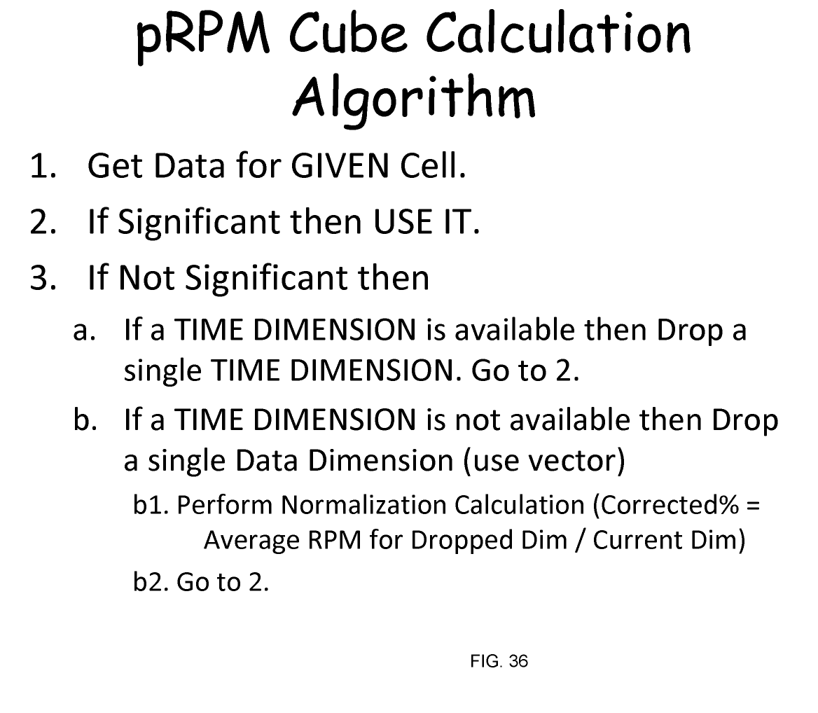

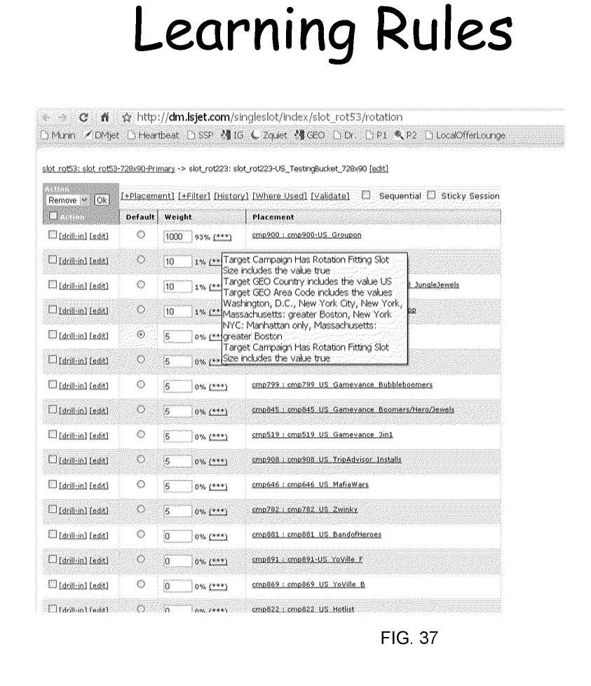

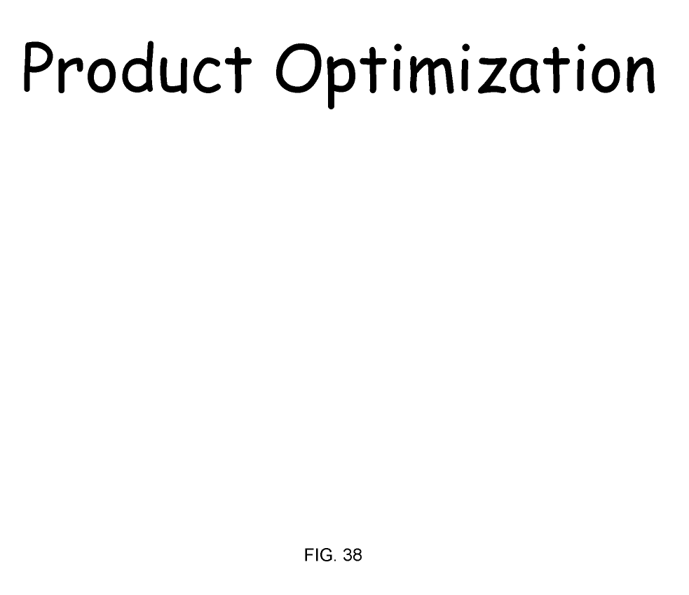

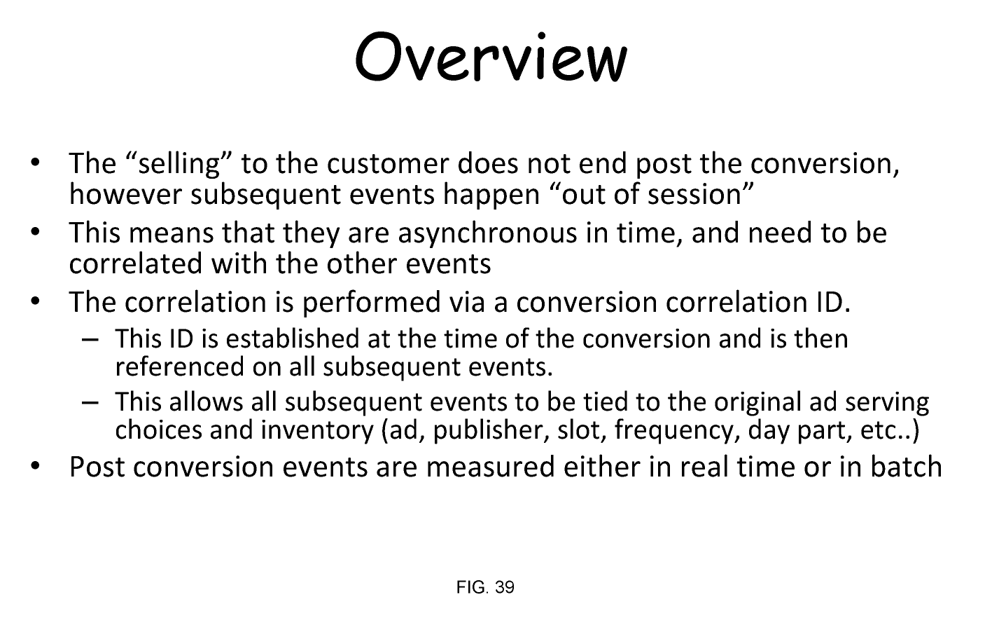

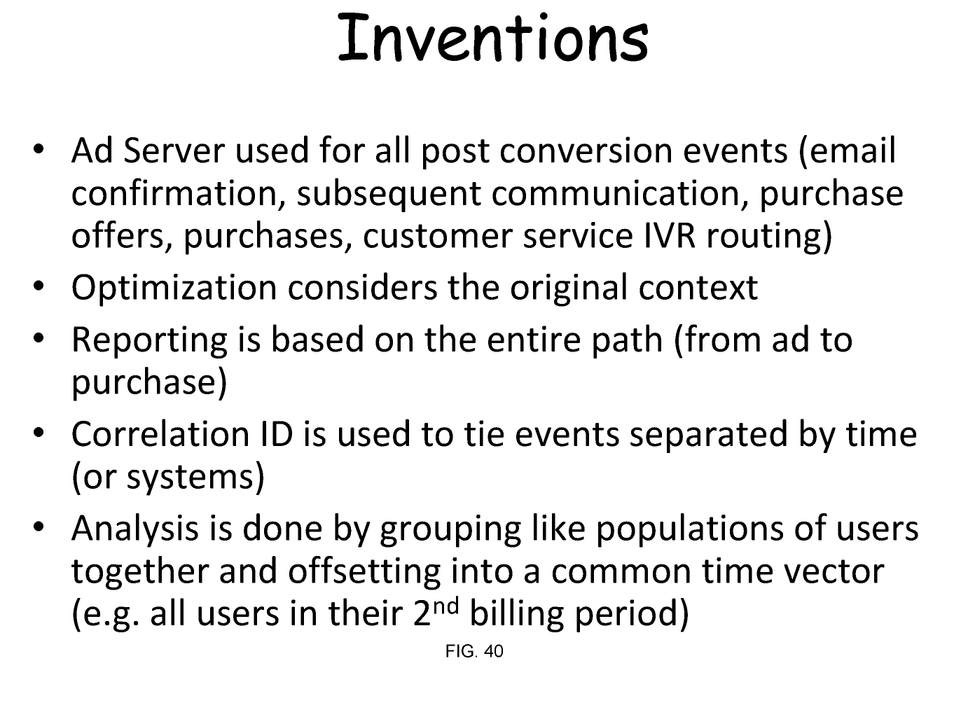

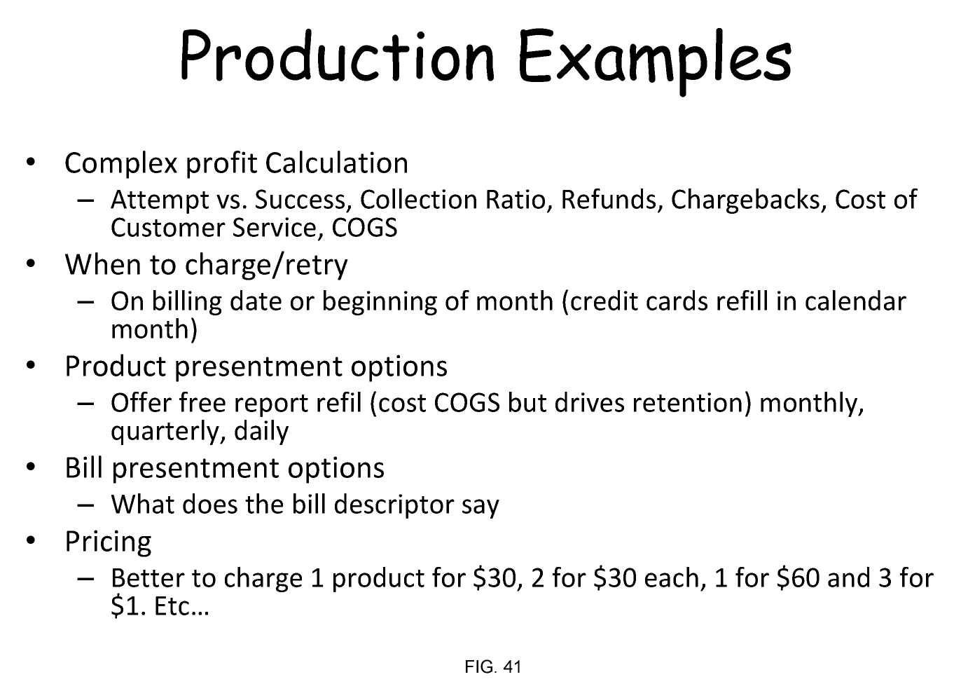

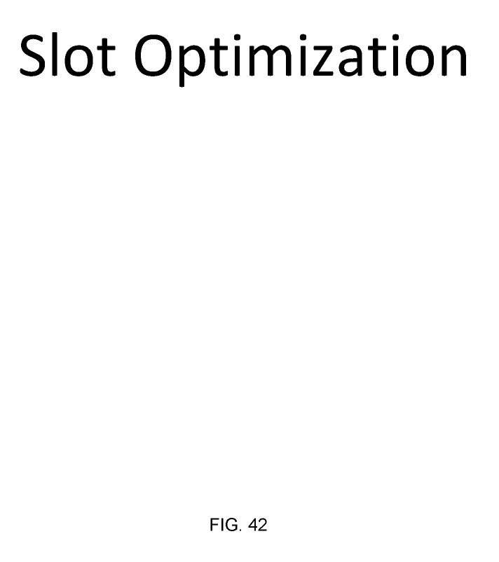

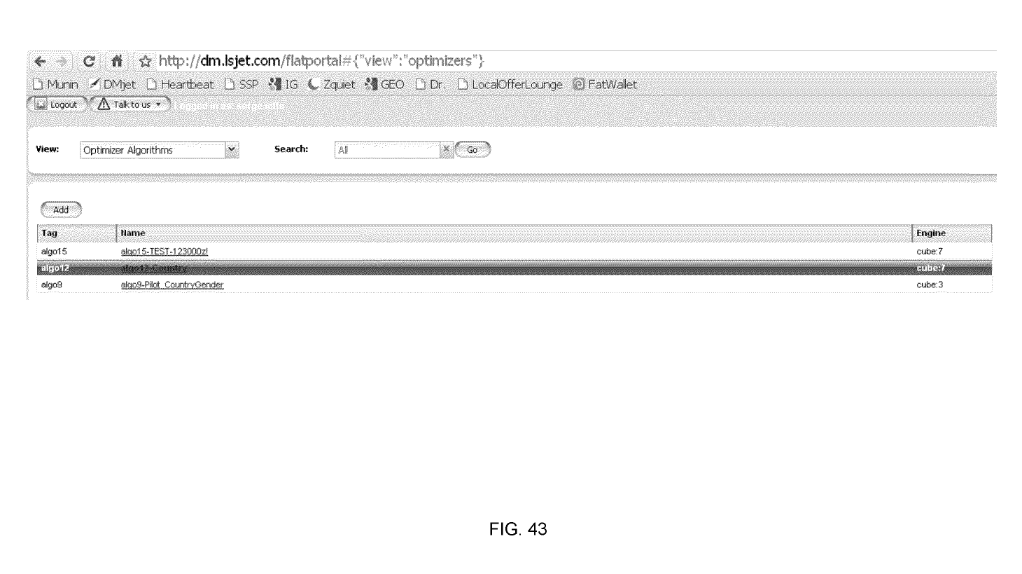

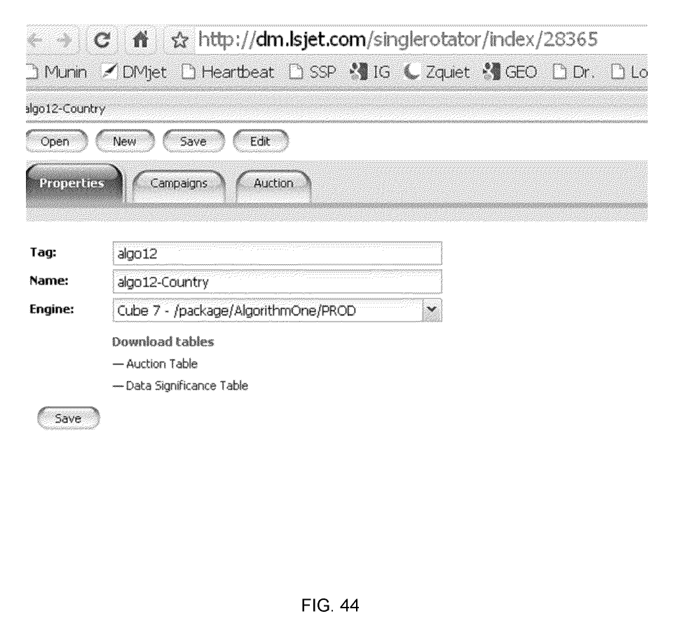

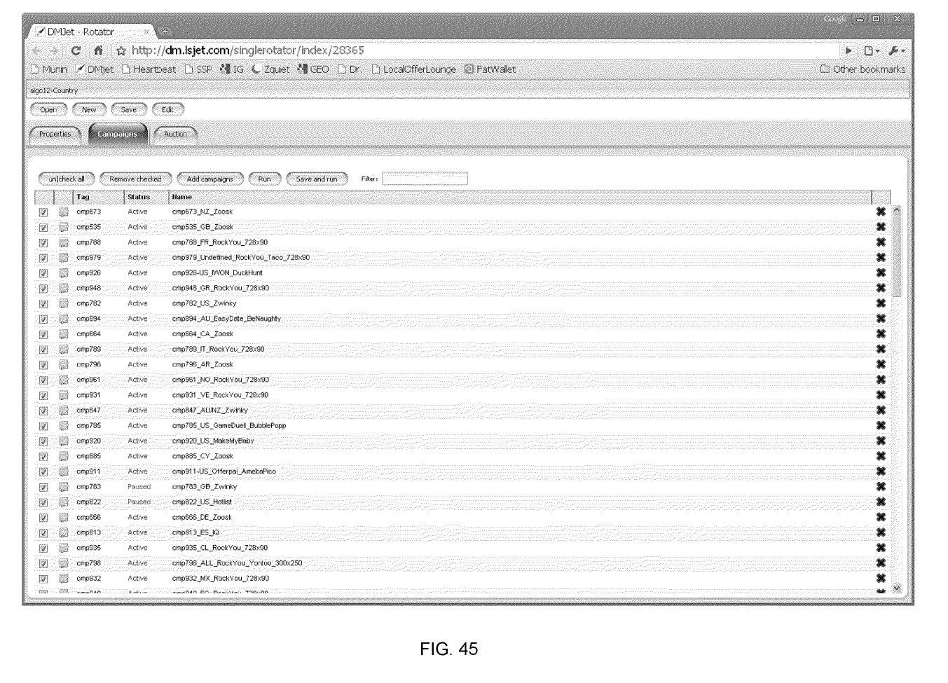

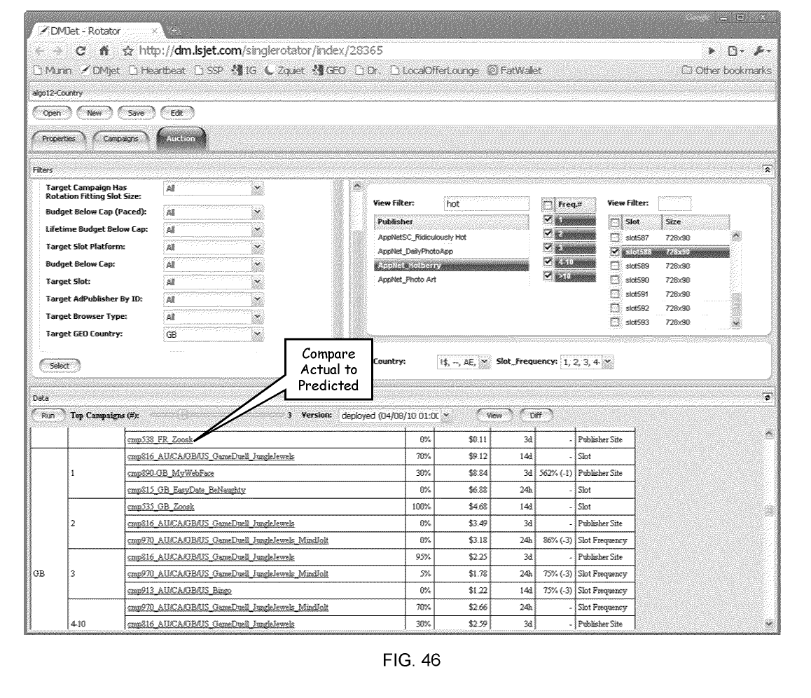

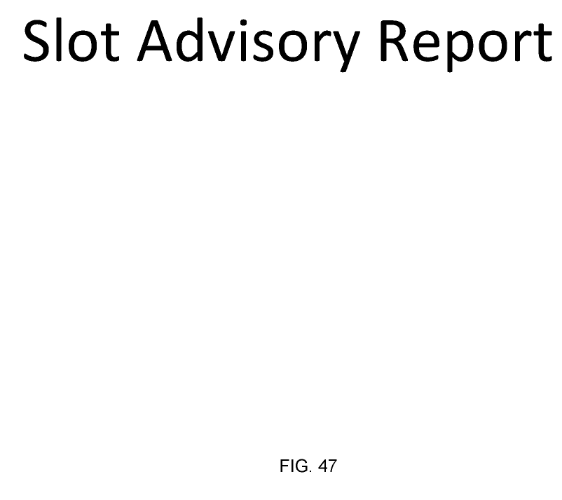

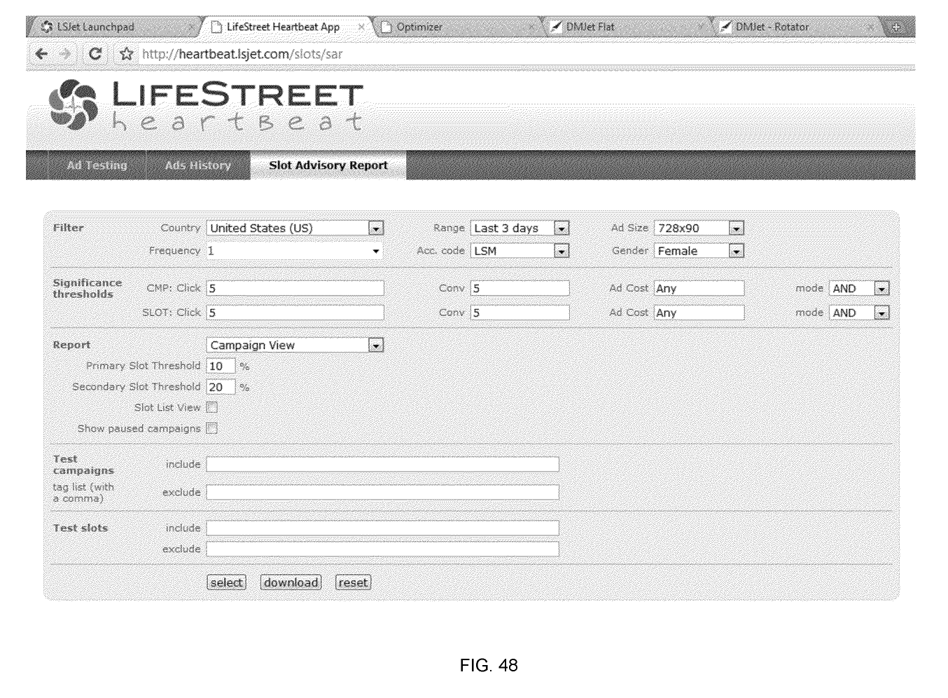

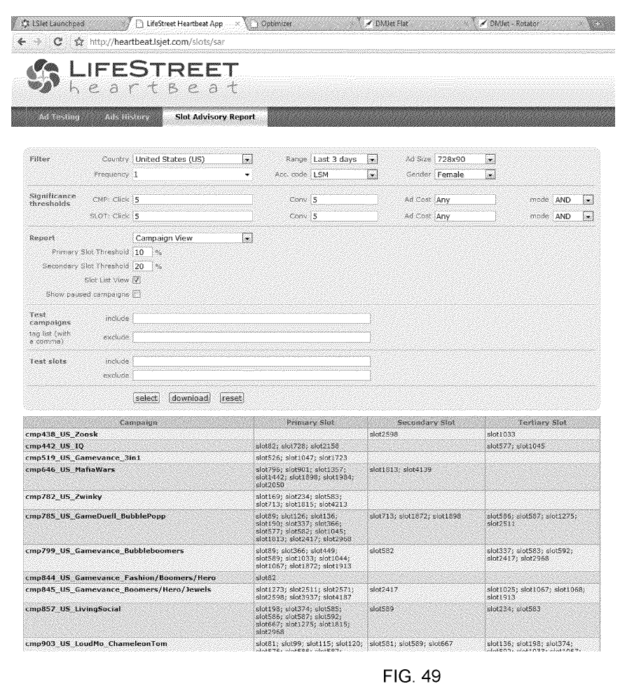

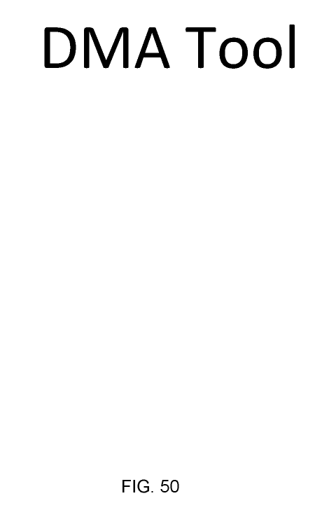

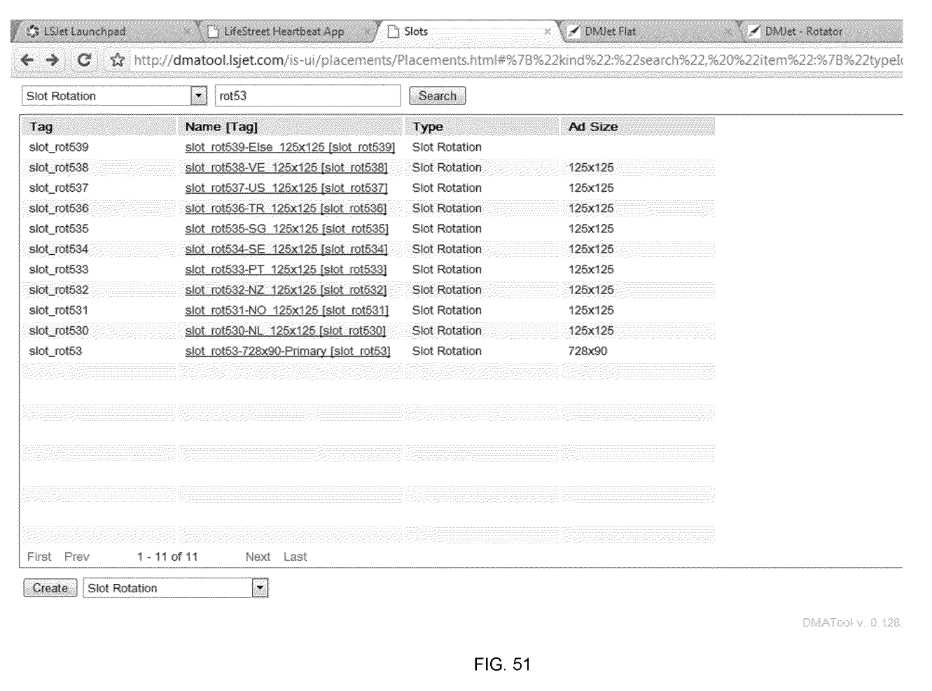

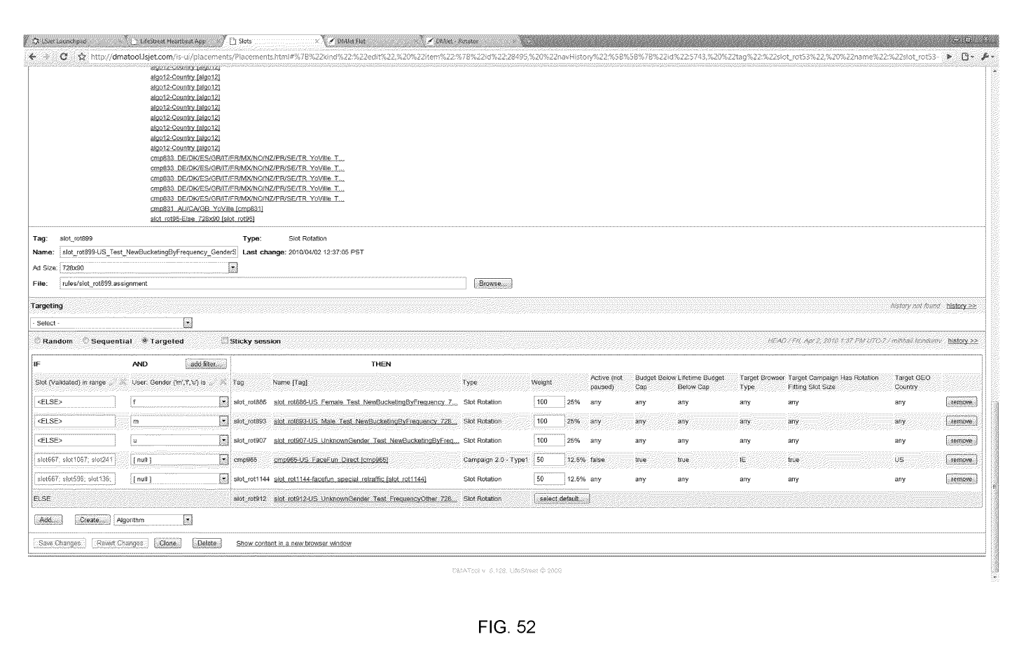

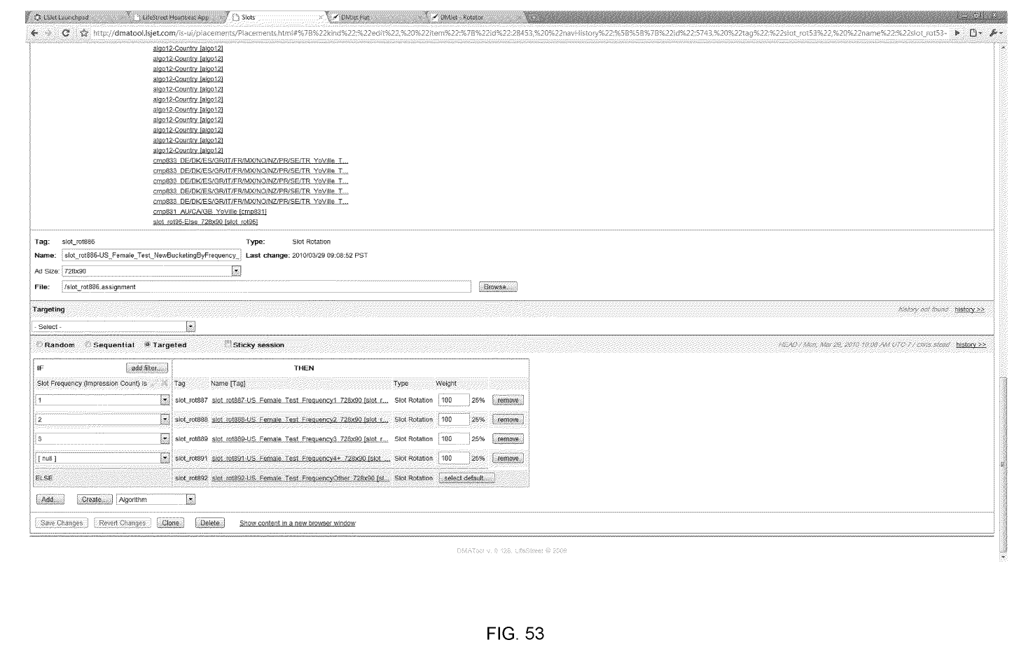

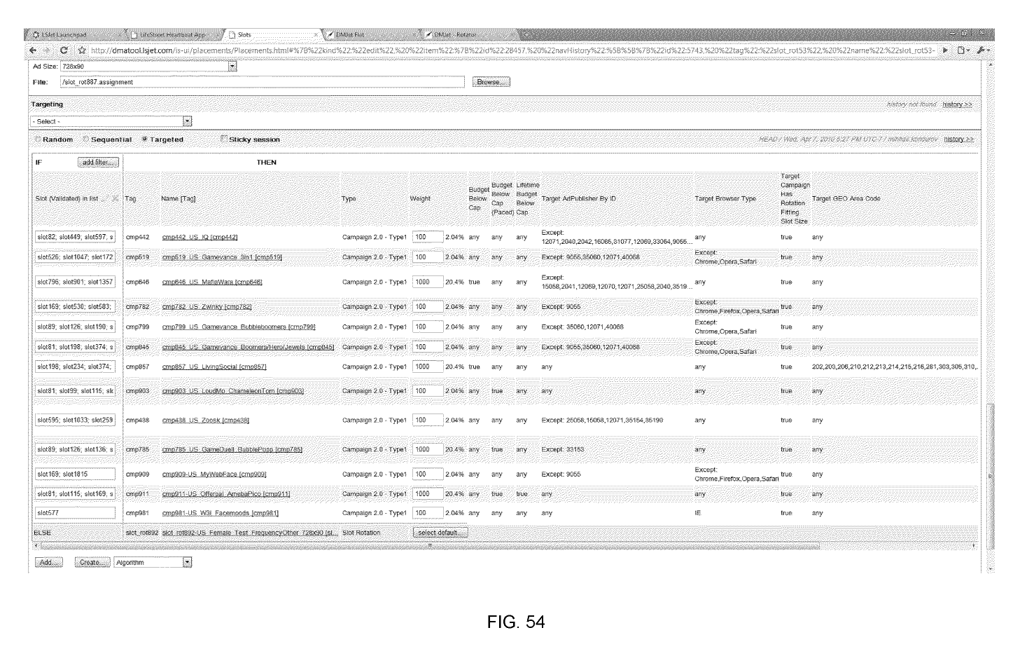

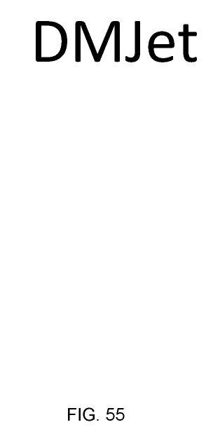

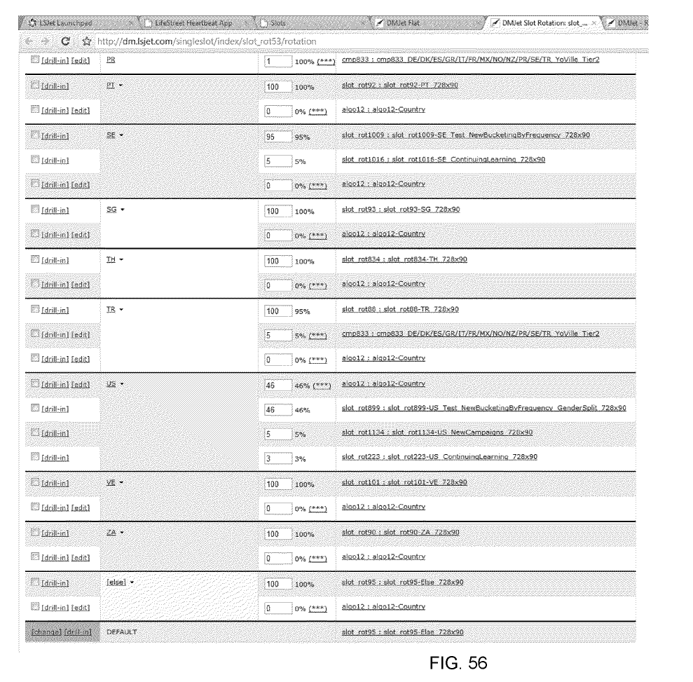

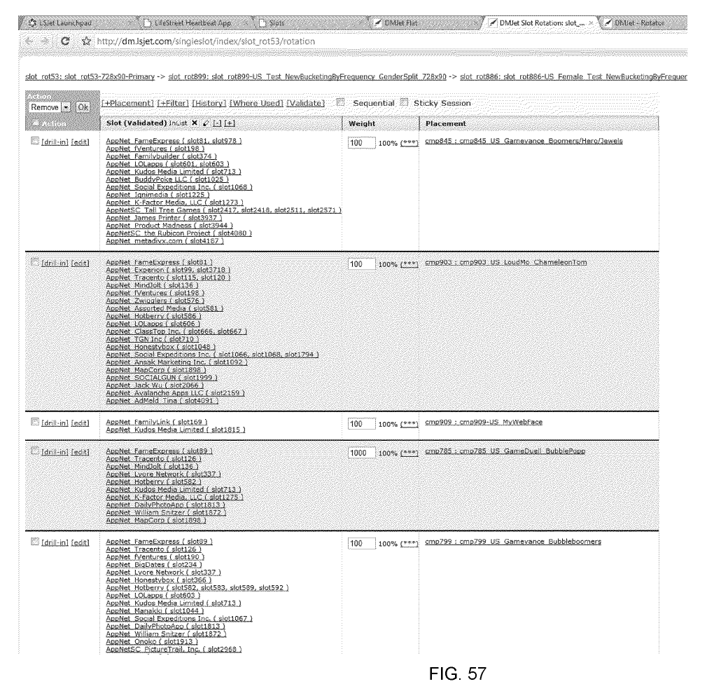

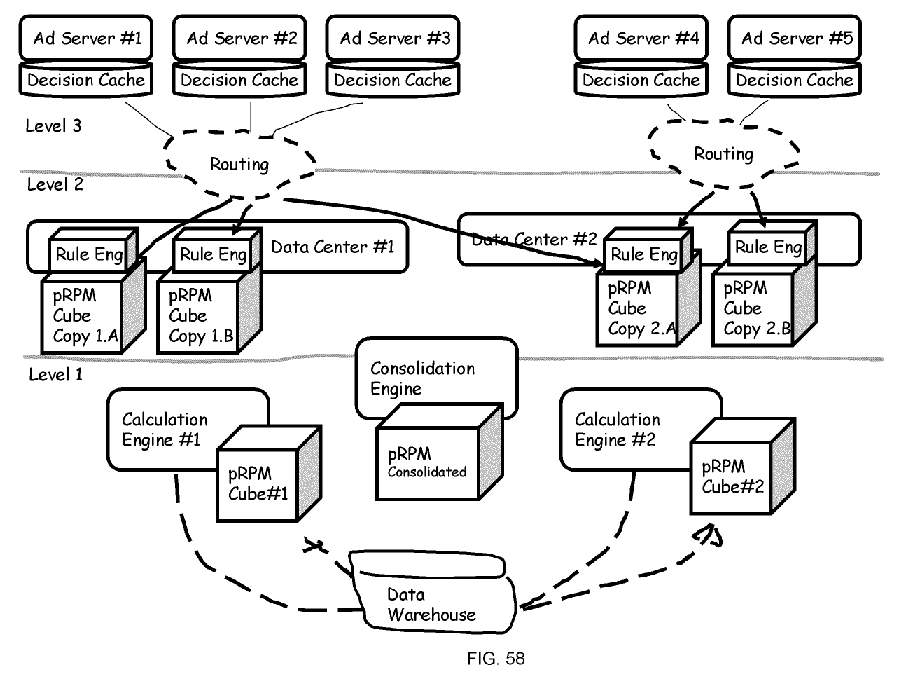

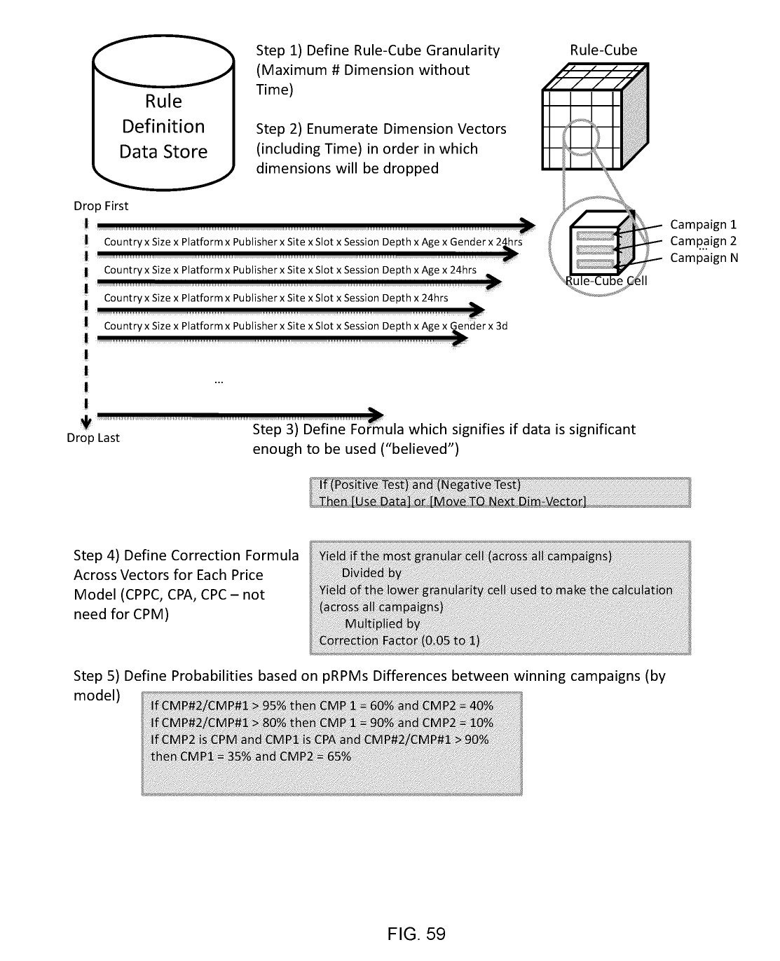

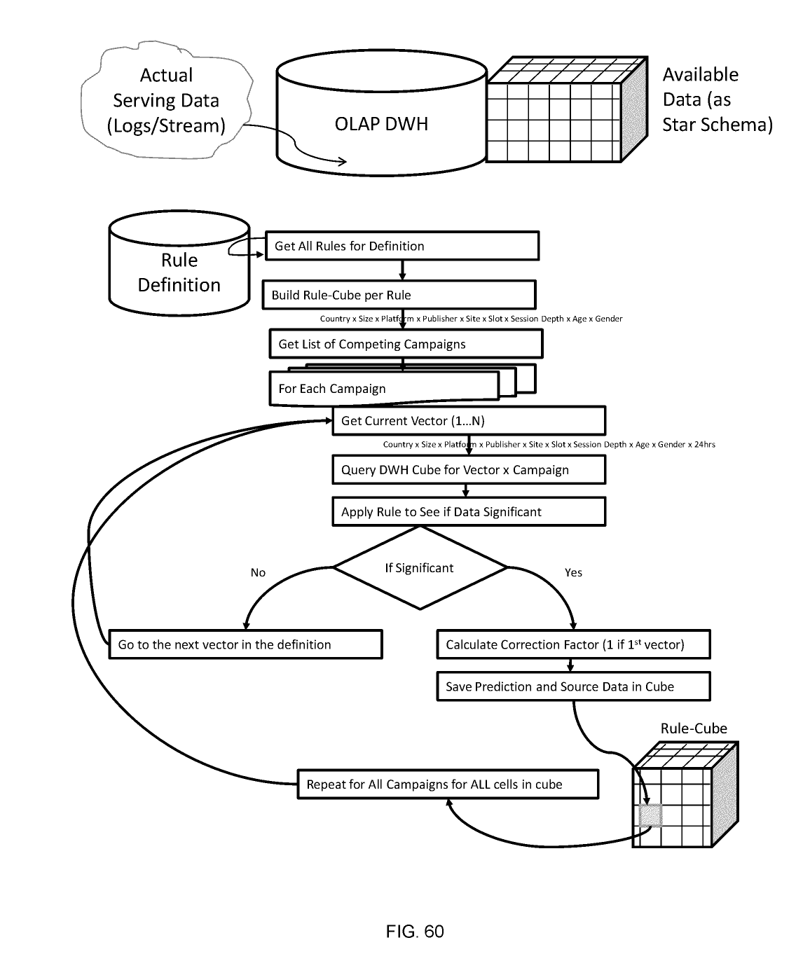

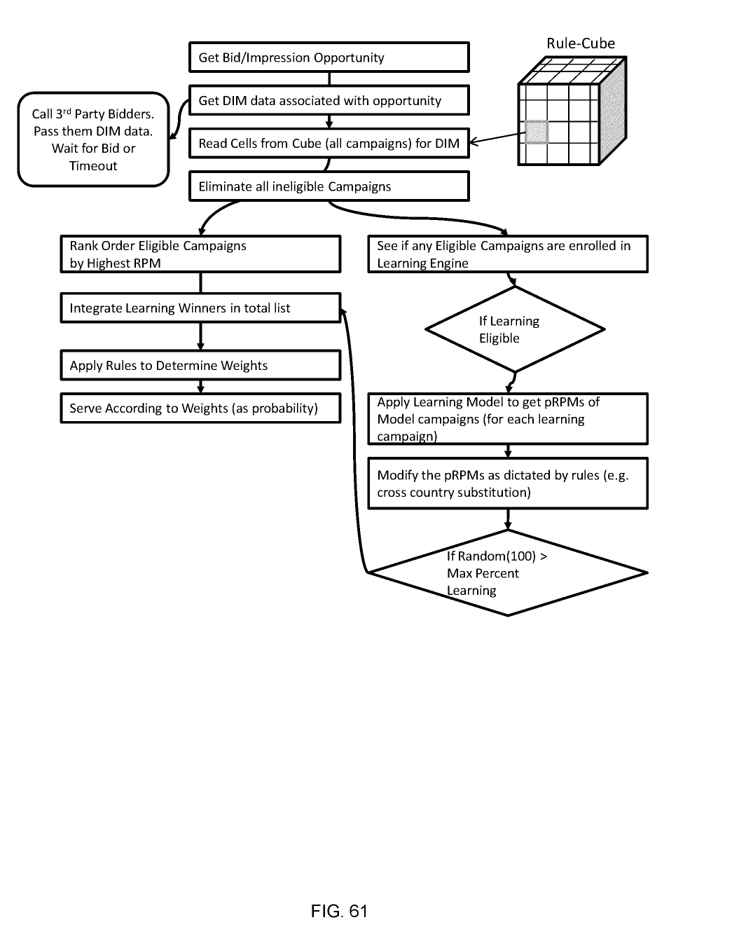

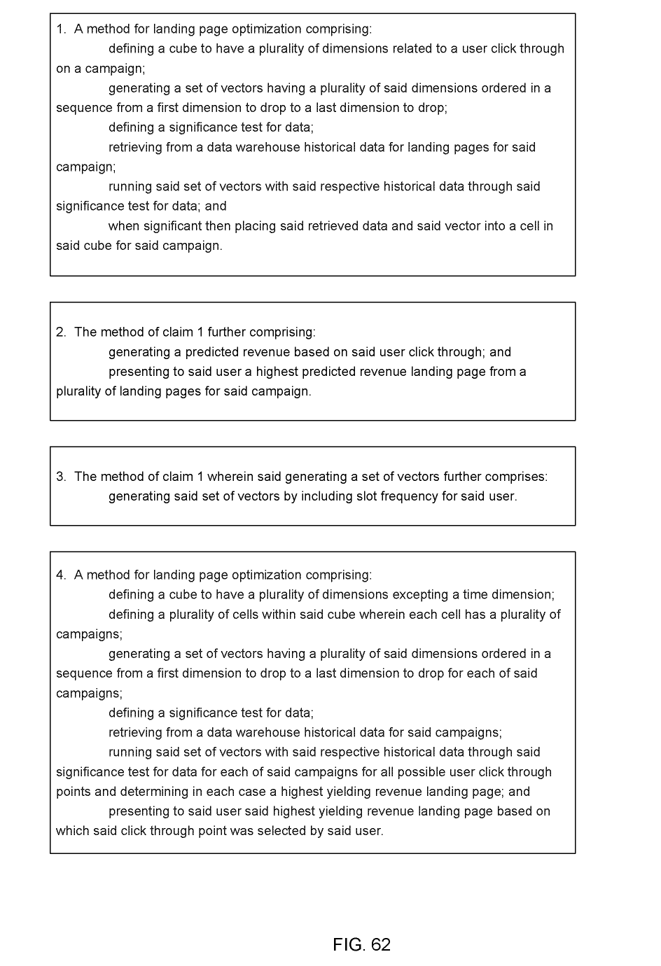

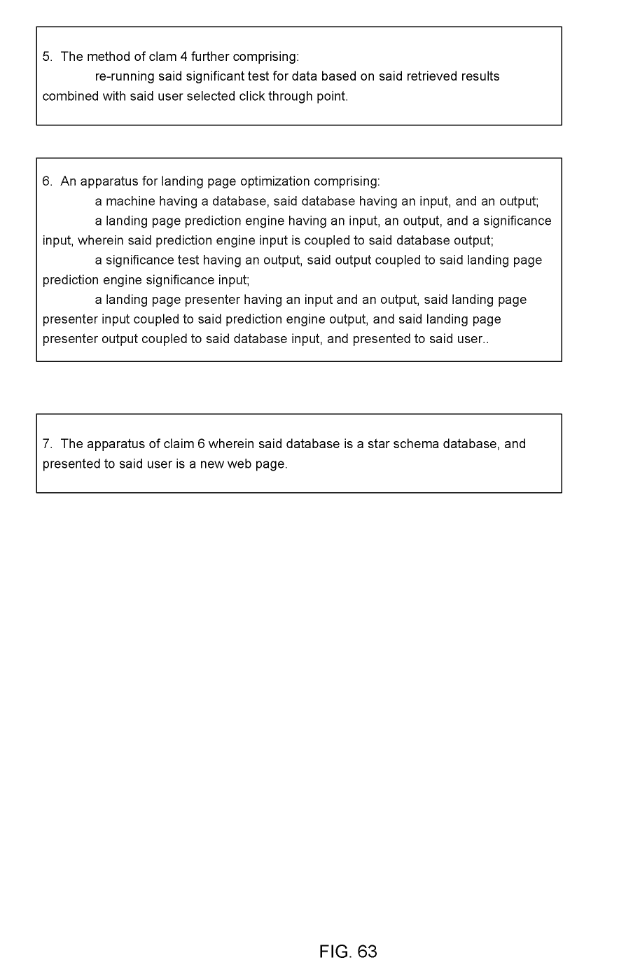

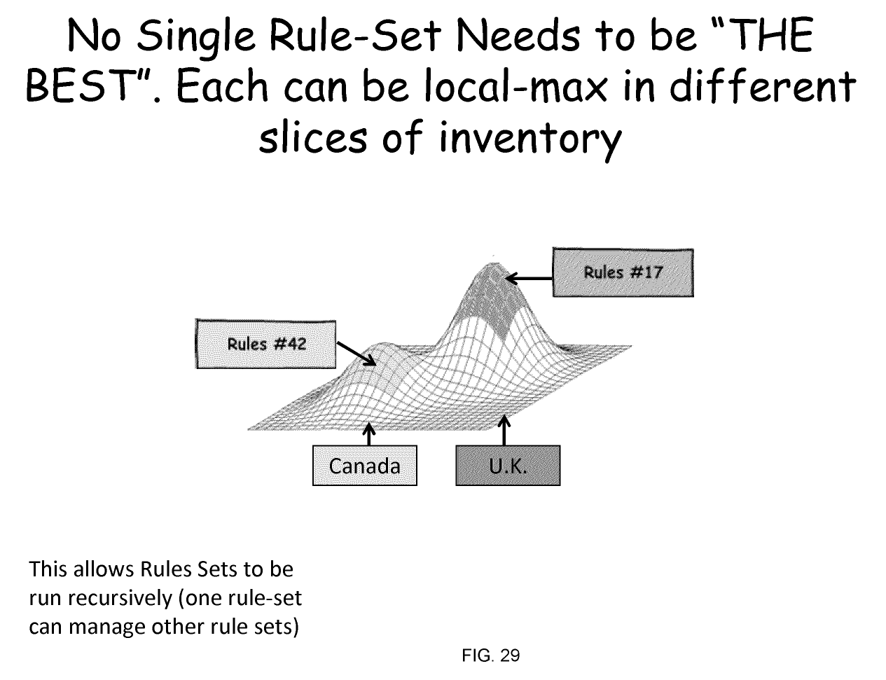

FIGS. 3-63 illustrate embodiments of the invention.

### INTRODUCTION

A brief introduction to some of the techniques in the present invention will be discussed. At times the format will be narrative in nature to assist the reader in understanding what has been achieved and the underlying rationale. The discussion will be centered on use of web pages and the Internet, however, the invention is not so limited and may be used wherever there are user interactions.

In general a first step (Step 1) is to get actual data about visitors, what they saw, how much was money made, etc. Take all this data and load it into a data warehouse (DWH) where the data warehouse is structured such that dimensions represent a cube. In one approach a star-schema may be used. That is for each thing being measured, it represents a dimension. For example, but not limited to, visitors as male or female represent a dimension, age may be another dimension, time of day another dimension, the country the visitor is in, etc.

It is important that data flows into the DWH because as shown later the optimizer relies on a cycle of a) do it, b) run it, c) see what happens, d) look at the data again. Thus the totality of the cycle is important.

So step 1 is get actual data into the DWH.

Step 2—is a high velocity campaign/inventory optimization where we are testing different rule sets that run the campaign and inventory. Rule sets are competing against each other.

A rule set consists of multiple pieces of definitions. There are two that are very important, first a vector representing the dimensions that we are going to use in a cube, and second, a test or formula that we will use to decide if we believe a given cell or not.

For the rule set we are going to need a rule engine, so off to the side you have a rule engine and for that rule engine we create a rule set. The rule set is going to contain multiple things, first is an enumeration of the vectors of the dimension we choose to use and the order of use. A shorthand for this may be, for example (as seen in some of the screen shots), a country, size, platform, publisher, size of slot, session depth, by time, etc. This is shorthand to specify a vector that says to first consider country, then size, then platform, then publisher, then size of slot, then session depth all by time, for example 24 hours, and if for some reason we don't believe in it (which is the second important thing i.e. the test to believe a given cell or not) then we start dropping dimensions of the vector. So in this case, dropping the dimension session depth we have the vector first consider country, then size, then platform, then publisher, then size of slot all by 24 hours. Note that the shorthand notation used is NOT a structural limitation of the vectors or how they are implemented, it is simply a shorthand way to show an enumeration and order.

Note that all combinations and permutations can be tried. Some may, from a human point of view, appear to be more likely than others, although this is not assured. For example, to a human it may appear that data within the last 24 hours is more reliable or likely to indicate something than data 3 days old, or from the last 3 days. Likewise 3 day old data may appear more reliable than data 2 weeks old. This is an a priori assumption that may or may not hold. Thus, to a human, the more recent inputs appear more reliable and relevant than time periods that look further back (2 days, 2 weeks, etc.).

In a similar vein, a site (e.g. website) includes multiple slots, or a publisher includes multiple sites, so it is reasonable to say we're most likely to believe data from a given slot but if we don't have data from a given slot that alternate slots within the site more or less behave similarly, or for a publisher all sites of a publisher behave similarly, or all sites for a publisher on a given platform behave similarly, or all publishers of a given size behave similarly for a specific country. That is the technique disclosed of dropping dimensions is to get to believable data.

So even though we, as humans, may have a reason a priori to order the vectors and dimensions to try something that we believe will work or is related, we really don't know until it's tested. Thus we pit one rule set against another to see which generates higher revenue. As noted (e.g. Figures) it is not possible based on computing power, the number of dimensions, and the very short time interval in which decisions must be made to try all possible combinations. This is a large time varying system with millions of variables—thus the challenge is to within a limited time interval, with limited resources, and limited and imperfect information to make a best decision to maximize revenue without losing out on other possibilities. Thus rule sets compete against each other.

Now in one embodiment of the invention as star schema is used. The star schema is composed of facts or metrics and dimensions (see for example, http://en.wikipedia.org/wiki/Star_schema).

So for example if we consider gender to be one dimension then it may contain 3 values: male, female, and unknown. So for example if we consider time to be a dimension then it may contain Apr. 1, 2011, 0100 hours, 0200 hours, etc., however granular time is specified. So for example if we consider a dimension to be slots, it may contain slot#1, slot#2, slot#3, etc. Thus the dimensions are the facets of a cube and what is within a given cell are the facts or metrics that relate to the dimensions. For example, dimensions may be how many counts, how many impressions, how many clicks, how many conversions, how many dollars did we spend in cost, how many dollars we got in revenue, etc. So for example at Jan. 1, 2011 at 0100 hours for slot#6 for males we may have 102,000 impressions. And for the same date, time, and slot for females we may have 88,888 impressions. And for the same date, time, and slot for unknowns we may have 160,000 impressions.

So as noted we want to enumerate the dimensions and then we enumerate the facts or metrics that we are interested in.

So the data coming in is parsed based on the dimensions and placed in the data warehouse (DWH) and may be queried. One skilled in the art will appreciate that various methods may be used to achieve this and since it is not germane to the invention is not discussed further here (see for example, OLAP (online analytical processing), http://en.wikipedia.org/wiki/OLAP).

For example, one can look at impressions by date, for example, yesterday there may have been 220 million impressions, and breaking it down by hour you get a finer resolution. Additionally you may look at each hour based on the dimension of country for even a finer resolution, or look at yesterday based solely on country. So for example, of the 220 million impressions, 45 million came from the country=US. So the intersection of country=US and hour=0900 and browser=Mozilla, may yield 1.2 million impressions. Conceptually the most granular level is that of the intersection of all possible dimensions. However as one of skill in the art will recognize to reach this most granular of levels is computationally expensive in time.

So the DWH represents a massive cube of events that actually happened and we want to get a smaller cube because we want to generate a predictive cube as fast as possible based on the historical massive cube. That is we want to manipulate the historical data to get a forward-looking statement. In this process we need to use historical information that is statistically significant or meaningful. If it is not significant along one or more dimensions, then those facets of the historical cube may be reduced or eliminated in building the predictive cube. That is we are attempting to get enough information in a dataset that we can believe. This should result in a prediction that time will show is valid rather than a prediction which is wildly off base. For example, if the historical dimension “browser” does not contribute any great significance then in one approach to formulating the predictive cube, the dimension browser may not be included. That is a prediction will not be made against browser. While in one approach a minimum number of dimensions in a predictive cube may be a goal, it is not the only approach. In another approach the goal is to get down to something that has large enough numbers for accurate predictions. Again the balance is between resources, such as computing resources and time deadlines and funding for finding the goal. Because each impression costs actual real dollars this is not an academic exercise. While the “historical” impressions have already been paid for, if they do not tell us anything or yield a prediction that is significant then we have to spend more actual dollars for impressions that will yield a prediction that is significant. For example, phrased another way how do we go about making a prediction based on 45 million impressions rather than 1 trillion impressions.

So we are done with Step 1—the data warehouse (DWH)

Step 2—start creating the rules.

The first step in creating the rules is to define a set of dimension vectors. We move from a dimension vector to another dimension vector as long as we believe we do not have significant data. That is, we go from one point in a vector to the next because we have failed a data significance test. Eventually we get to a dimension set where we believe the data. WE then stop and in one embodiment, retrofit the data into the cell in question. For example, suppose we have the simple situation where we have a publisher, a slot, 24 hours (worth of data), and one week (worth of data). This yields a 4 dimensional cube. So we could describe this as publisher by slot by 24 hours, and publisher by slot by 1 week. So inside this we need to place data (numbers), the most important being predicted RPM (revenue per thousand impressions) (pRPM).

So, we'll look at this particular publisher, this particular slot (for example, publisher #7, slot #5) for a campaign (for example, campaign #1) that we are working on. (Note that we will be repeating this for each campaign.) We get data for 24 hours and suppose we say “we don't believe the data”. Suppose for the sake of illustration that we are working on a CPA (cost per action) campaign. Thus we have impressions, and conversions. So, a really simple believability test would be to say that we believe the data if we see more than 10 conversions. So, if in the 24 hour period we see 1000 impressions but 0 conversions, then it fails the believability test. Otherwise we would have a 0 pRPM. So the simplest believability test is: conversions >Y, where Y is some predefined positive integer. Now continuing the example we look at the 7 days (1 week) and assume we got 10,000 impressions and 2 conversions, and we still say “we don't believe it”, so we drop slot #5, and just look at publisher #7. Now assume that publisher #7 has not only slot #5 but had slot #6, slot #7. So we look at publisher #7 and find that publisher #7 over the 7 day period had 100,000 impressions and 12 conversions (a yield of (12/100,000)×(whatever the price is) to give you a pRPM). This passes the simple believability test. In one embodiment of the invention a correction factor may be applied to get the pRPM. Continuing this example, assume no correction factor and the price of $1.50. Now we go back into this particular cell, i.e. publisher #7, slot #5, and predict $1.50 and may note as well in the cell that we dropped the slot dimension, note in the cell that no correction factor was applied, and note in the cell any other information we wish.

Now we proceed to publisher #7, slot #6 and repeat the above process. We continue these processes till we are finished. This process is also repeated for each campaign.

So from the above process we know that we would not have found the $1.50 in the DWH had we looked because for publisher #7, slot #5 we would have found a $0.00 RPM since we had no conversions. Now by putting the $1.50 in the pRPM we have in fact put something less accurate than the actual data in the pRPM but we have put in a “believable” value for a pRPM based on a dropped dimension that results in less granularity. Alternatively, we refer to this as looking at another point on the vector (that generally results in less granularity). That is rather than basing the pRPM on vector publisher #7×slot #5×24 hours it was based on vector publisher #7×7 days. Note that we must have a pRPM because when we start serving and publisher #7 comes to us with an impression on slot #5 we have to decide what to show there. Normally the decision will be to place that which returns the most money. So if campaign #1 for publisher #7 for slot #5 has a pRPM of $1.50 and campaign #3 for publisher #7 for slot #5 has a pRPM of $1.60, we normally would serve up campaign #3 for $1.60 absent any other considerations. In some embodiments, the rules for picking a campaign may decide based on factors like believability and so may apportion a slot among various campaigns.

Clearly pRPM and the resulting actual numbers are very important. This is why the pRPM process is repeated (iterated) often as the dynamics of serving and of user clicks, conversions, time, etc. are constantly changing. What may be optimum at Feb. 10, 2011 at 0100 to 0200 in the US for publisher #3 slot #23 for browser Internet Explorer for unknown gender may be totally different at time 0200-0300.

Thus the prediction and determining if it's right or wrong is very important. Thus we keep improving the rules so that we are right more often than we are wrong and in the aggregate the amount of money made from one rule set is more than from another rule set. In one embodiment of the invention, rule sets are run side by side and we look at their RPM's. Based on this we run another iteration looking for a rule set to best the current winner. This is referred to as high velocity competition. Note that in one embodiment of the invention the side by side running is done in real time on users via an A/B traffic split. For example, real traffic is taken and randomly split and the testing is done on each split.

The more traffic we have the faster in real time we can come to a decision.

Note that in one embodiment of the invention, rule sets are competing against each other for a given campaign. At a “higher” level campaigns may also be competing against each other.

A campaign optimizer has a set of predictions that allows it to pick the best performing campaign for a piece of inventory.

So for example, rule set #1 may look at publisher×slot×24 hours and another rule set #2 looks at the same publisher×slot×24 hours but also considers gender=female (i.e. publisher×slot×gender (female)×24 hours). Now if rule set #2 is “out performing” rule set #1, it wins. Now “out performing” can be measured as in actual RPM, total revenue, etc. That is having a rule set #2 with a pRPM of $2.00 and an actual RPM of $2.00 says that the pRPM is an accurate predictor. Rule set #1 may have a pRPM of $1.75 and an actual RPM of $2.05 which indicates that rule set #1 is not very good at predicting and may need a correction factor.

Note that the example above has a very very simple variation between them. In actual practice the difference in the vectors may be quite significant for example; rule set #4 publisher×slot×24 hours, rule set #6 gender×age×country×2 days in 7 days. Thus we see that the only thing in common is that of time, and even then it is of a different magnitude.

The A/B comparison is against rule sets.

So for example suppose that an ad is for female gloves and rule set #7 has publisher×X×Y×Z where X, Y, Z are not gender. One looking at this might say “Hey I think rule set #7 is underperforming because it's not taking into account gender. I′m going to create a new rule set #8 that takes gender into account.” Now rule set #8 might be publisher×X×Y×Z×female gender, where X, Y, Z are not gender. Now if rule set #8 wins over rule set #7 then that was a good decision. If it loses then it was not a good decision (it might be that the gloves look neutral and thus appeal to all genders (male, female, unknown)).

Note that while dimension vectors are part of the definition of a rule set, the rule set contains much more, for example how to determine a winner and a loser.

Note that we take a given rule set and use it to fill out the entire cube with pRPM. We then take a different rule set as explained above and use it to fill out an entire cube with pRPM. It is these 2 rule sets that are run in the A/B test. We then make some amount of money based on the rule sets where each rule set has a different idea of what should be served up to customers in real time, such as which ad is better, which landing page is better, etc. That is whatever thing it is that we are optimizing (e.g. landing page, ad, colors, slots, gender, campaign, etc.).

Note that rule sets are constantly competing. This is the high velocity competition.

For example, in the case of the campaign (also called inventory) optimizer, the thing that competes with each other are campaign rule sets. In the case of a creative optimizer, the thing that competes with each other are creative rule sets. That is creatives. Creatives are considered first order things, whereas rule sets are second order derivatives. Recall it's not the campaigns that are directly competing against each other but rather the rule sets that are driving a campaign that are competing.

Conceptually the idea is that in any advertising opportunity there are an infinite amount of points for optimization. For each point of optimization you can have a universal placement server which is a base dimension if you will. The next step “up” is that now that you have these points you can write very smart robots to manage each of those points of optimization. So for example, we have described above a robot that can manage campaign optimization. The universal placement server allows you to break any advertising opportunity into as many points of optimization as you choose and to control the traffic.

So that's the heart, if you will, of one embodiment of the invention

So once you have that, then for each point of optimization which are also referred to as gates, you have in any advertizing (aka advertising) opportunity an infinite number of points of optimization. Passing through each point of optimization is making a decision about something. Once you have made a decision you go back (for optimization) so we often will refer to this as a gate and going through a gate. So for example, in one embodiment, 5 big gates may be used. A key part of a system is a universal placement engine that allows you to take any transaction (e.g. an advertising transaction) and model it as a whole series of decisions about what to do with traffic. And once you can model and measure it that way then you can begin to optimize each one.

So now let's talk about in one embodiment of the invention a first gate, how to optimize the selection of the campaign for a given unit of inventory. Realize that one objective is to ultimately arrive at a pRPM against some kind of cube. So the first thing we need to do is articulate the dimensions we will use in the cube. What that means is that with the exception of the time dimension (which we do not use in a cube), anything that is not a time dimension we will end up at run time with a cube that contains, for example, country, size, platform, publisher, size of slots, sessions, age, gender, etc. So we look into each one of those cells in the cube which will give us a number and we contribute that number to another rule set for it to decide what to do with it. In one embodiment, a rudimentary approach would be to pick the highest number. This however may not be the best choice as will be explained.

So how do we pick it? We have the totality of the cube which is the cube that is the intersection of all the dimensions we choose to use. Then we write out step by step by step, or if you choose by using shorthand, how we are going to go from, in a star schema approach how to drop dimensions. The reason we drop a dimension is that the historical data that we have is something we choose not to believe given whatever our rule for believability is.

Note that as will be explained “believability” is yet another thing that we can test. That is there is no reason not to have believability compete against something else. So for example we could take 2 identical dimensions and in the rules we could change not the definition of the cube but rather the definition of believability and then have them compete against each other. As in other tests they can be run side by side, and for example, the winner could be the one that made more money on a unit basis. This running side by side (A/B test) and looking at what makes the most money on a unit basis is a good measure of a “winner. Underlying this test “winner” is the assumption (which can be measured, as is explained) that the test itself is statistically significant (e.g. two-tailed Z test, Chi-squared, test, etc.). That is whenever we run an A/B split (aka A/B test) then we can take for example the two-tailed Z test, calculate sigma and if sigma is greater than 3 we can decide to say that it is statistically significant, that is that it passes some preset statistical threshold.

Note that while we have discussed at length an A/B test or A/B split, the invention is not so limited, and the techniques disclosed may be applied to multi-way tests. For example, A/B/C, A/B/C/D, A/B/C/D/E and any n-way test where n is an arbitrary number in a test or split of A/B/C/ . . . /n.

Okay so we have defined the vectors to use. And the vectors in one embodiment could be random. However, for a given approach one could say that while they are random, we believe that age is really important, so in this case we would allow the dropping of dimensions except for age. In any case the vectors are enumerated from the most granular to the least granular. We can enumerate them using another rule set or we can use shorthand to enumerate them. So we first enumerate the possibilities that we want to consider. Generally the finite set of enumerations will be done a person who is running the tests. For example a DMA (direct marking associate) user named “Chris” may decide to run a test. Chris may say “I've looked at this cube, I've looked at the money it's making, I′ve looked at the details of decisions it's making and I think I want to consider gender.” That is the user has decided that gender should be considered. While the techniques discussed put machinery in place to crank though the process of considering an idea, for example, such as gender. The idea may come from a user rather than as a random pick of one of the variables, dimensions, etc. available.

For example, if we are doing creative testing and someone wants to test the headline “Free socks” and someone else says no no no I want to test “Complimentary socks”. An A/B test can be run to see which creative wins.

So for example, the system is running along with a rule set that is the control set because it's winning but it does not consider age and the user believes that age is important and if taken into account we could make more money. So a rule set that considers age is generated (with the attendant pRPM, believability, etc.). It is important to understand that the rule set that considers age is generated by the machine based on all the factors and techniques discussed, however the pRPM is not looked at to determine whether to run the rule set or not, rather whatever the result of the many pRPM calculations that may be done to consider gender are used to select candidates to test and it is these candidates that are then run against the currently running rule set in an A/B test. The winner is which generates more money in a real time contest.

For example, 10,000 times a second someone gives you the opportunity to serve up ads. That is, a machine, such as, but not limited to, a server must serve up 10,000 ads. The machine must decide which ads to serve up. The machine uses the pRPM as a basis for which ads to serve. The machine can be a cluster of machines.

So the machines must decide when passing the first gate, what campaign, what advertiser, is most likely to make us the most money if we show it here.

The yield curves being what they are, the machines will likely be wrong 99.99% of the time.

We are in the performance business, which means there are impressions, there are clicks, there are conversions, and there are post conversions. So, for every 10,000 impressions in this business you can get roughly 10 clicks, and roughly 1 conversion. So, on each and every one of these 10,000 impressions we need to make a prediction on what is going to work. We will likely be proven right even if we are right on 1 in 10,000 and so we will fail 99.99% of the time. That is we need to serve 10,000 ads to get 1 conversion. Now by using the techniques disclosed if we can reduce the failure rate to 99.98% then we have doubled the revenue for the same cost of the impressions. That is, for the cost of the 10,000 impressions we now have 2 conversions.

So the machines make these serving decisions and if for example, a first rule set yields 0.8 conversions per 10,000 impressions, and a second rule set yields 1.2 conversions per 10,000 impressions, then the second rule set is making 50% more money for you than the first rule set.

Note that rules set are also called algos or algorithms. Now for the A/B test, we may decide to split the traffic 80%/20% (denoted 80/20) with 80% of the traffic going to the control rule set which is the current winner. For example, in the consider the gender case, we might be really foolish to use even a 50/50 split until we know that the actual revenue from gender is greater than the non-gender case. Thus, an 80/20 or even 90/10, 95/5, or more likely a 99/1 split may be desirable.

Note that for the A/B test where the A rule set is non-gender and the rule set for B takes gender into account, the ads, the slots, etc. are all identical. So where's the variation that can take into account the gender if the ad and the placement, etc. is identical? Let's assume we have different advertisers competing, say for example, one is a dating advertiser and the other one is a credit monitoring advertiser. We always have a set of advertisers represented by a set of campaigns. We are optimizing which campaign to show. So when we consider gender the machine may make the decision that dating ads are not smart to show to people under the age of 30 for example.

Another example, assume we have only two advertisers competing on a network. They are always competing. Advertisers may come and go but they are always competing. The user looks at this and thinks that age is important. That is the user believes that taking age into account will make more money for the network as a whole regardless of the campaign, regardless of the publisher, etc. Note it is not that advertiser A or B will be optimized, which may or may not be the case, it's that we believe taking age into account will make us more money overall. The machine when generating the cells while taking into account age happens to discover for example, that dating services do well (via pRPM) for ages over 30 and under 50. Now an impression comes in that has age in it and it was randomly split between the test case (age considered) and the control (age not considered), if it went to the test age was considered, and if it went to the control age was not considered. And based on this the machine determines that it would be better off serving the dating campaign not the other campaign.

Algos have a rule set which is comprised of dimension vectors, significance test, significance thresholds, selections rules, etc.

Realize that if we let an algorithm run long enough we'll get statistical certainty that one algo is better than another algo.

The reason age could matter is although the ad didn't change, the advertiser didn't change, some advertisers just happen to do really well with a certain age group and for other advertisers age makes no difference.

So for example, we're running a campaign and we're running a test where we've added a factor such as age, gender, etc. in a rule set, a traffic split decision may be made by a human using the universal placement server which takes the traffic and splits it based on rules. For example a really simple rule would be to take all the traffic and do a 98.6/1.4 split.

What is to be further appreciated is that while we are doing the techniques described the campaigns are always changing, as are the slots always changing, and this is all happening in real time on an ever changing groups of users. Thus we have a huge huge dynamical system where we are attempting to figure out in real time how to maximize making money.

In one embodiment of the invention, slots may be purchased in advance, advertisers and publishers may be secured and campaigns then designed based upon the further constraint that an advertiser is only willing to pay for conversions. Within these constraints is where we maximize our revenue. So for example if an advertiser is willing to pay $10 per conversion and we can generate that conversion for $7 we make $3 per conversion. However, this is not a very compelling approach. A more enticing approach is where the conversion is still worth $10 to an advertiser but we only charge them $5 for the conversion. Clearly it's a no-brainer to sign up for this approach as there's nothing to lose and everything to gain. So how do we make money? Simple, generate that conversion for $2 and we make $3. Under this second example scenario one can see that what we really want to do is not maximize our revenue per se but rather maximize the amount of money that we pay publishers. In this way they are willing to give us the traffic. So in this case the job of the optimizer is to get the biggest amount of dollars that we can to the publishers. We do not have a finite goods problem and so are able to service an unlimited number of publishers which means that optimization based on publishers is not a priority and a lower “yielding” publisher simply means that that publisher is not making a higher RPM. A publisher may not “yield” as well as another based on bad inventory, etc.

It is important to note that the publishers do not really care how many impressions you serve up as they own the impressions, the advertisers on the other hand need to be well monetizing advertisers. For example, if a law practice that specialized only in wine cork contracts were to come to us and say “I want to run a promotion for our law practice” we would say “fine but you're not likely to be a well monetizing advertiser” because your chances on getting traffic are very low.

In the real world the advertisers often have a dynamic auction that they have to win whereas the publishers have really unlimited impressions and the more the better.

Okay we have a data warehouse, we've started a rule set which consists of many things but does start with a vector of dimensions, that is we are going to enumerate vectors of dimensions. So next we need to build the cube that we will be using at run time which is an intersection of all the dimensions except time. Now we have the cube and have the cells. Each cell is filled out with a number, for example, representing money.

So for example, continuing with the $1.50 example above we have a publisher by slot cube even though we managed to derive the $1.50 by only looking at the publisher. Now in each of the cells you have to have N entries corresponding to the N campaigns that are currently running at any given time. (N.B. N is not the same as, and is not to be confused with the n of n-way). So a position needs to be taken as to what campaign 1 is worth, what campaign 2 is worth, . . . , what campaign N is worth. After this is done we need to put the metrics or facts in. We will put in the number of impressions, the yield curve, and the pRPM. In one embodiment, the pRPM is defined as the yield curve times the price for what you are getting paid. In one embodiment, the yield curve is defined as the ratio between the thing that you get revenue for and the amount you pay out for the thing. In the industry there are some terms associated with the thing called CPM (cost per thousand impressions), CPC (cost per click), CPA (cost per action/conversion). The CPM yield curve by definition is 100%. That is if you're buying an impression and selling an impression the yield is 100%. A CPC yield curve might easily be in the range of 1 in 1000 to 1 in 10,000, or more or less, clearly much less than 1 in 1 (100%). And CPM can be easily one or more orders of magnitude less than CPC. So continuing the example, the yield curve is conversions divided by impressions (conversions/impressions) which could be, for example, 1/10000. Note also that the price is the price at any given time since price may also vary. So for example if yesterday we are getting paid $1.00 for something and today we are getting paid $1.20, while the yield curve has not changed the price today is 20% more attractive. So we take the current price and multiply it by the historical yield curve. Thus the pRPM can vary based on this. This is also a reason it is important to separate the yield curve from the price. Realize that the yield curve is not sensitive to the price, rather it is the responsiveness of the audience to that which is being promoted. Stated another way, the yield curve is the historical tendency of the audience or visitors to click. We are talking about a click yield, which in the industry is often referred to as CTR (click through rate). That is for a given campaign, for a given piece of inventory, for a given audience, there is a historical yield. It does not matter what we are getting paid for the CTR. For example, a campaign that is promoting a muscle car in a man's online magazine or website may have a higher CTR than the same campaign in an online music magazine or website.

Now when we being to drop dimensions, it's quite possible that we are no longer looking at apples to apples but rather apples to oranges. Session depth is also known as frequency. Slot frequency is how many times a given visitor has looked at, or seen, or had presented a given slot. It is a measure of distractibility. For example, upon first visiting Yahoo's home page (as measured in say a 24 hour period) there may be a Medium Rectangular slot of 300×250 pixels, and so this would be a session depth of one or a slot frequency of one. Now if you hit the refresh button this would be a session depth of 2 or a slot frequency of 2 for that Medium Rectangle (mrec). Now session depth is important because different ads can be placed in this mrec depending upon the session depth. For example, it is reasonable to assume that on your first visit to a new page it is more likely a user will look at an ad in a slot, than on the 2nd, 3rd, 4th, etc. visit to the same page in the same slot. That is the user is more likely to ignore the ad in the slot on repeated visits to that page. Accordingly, it also follows that advertisers are more likely to pay more for less session depth or less slot frequency. For example, advertiser A may have purchased slot frequency=1, advertiser B may have purchased slot frequency=2, 3, 4, and advertiser A or B or another advertiser may have purchased other slots beyond 4. Now the distractibility versus slot frequency curve need not, and in fact, generally is not linear. If your distractibility at slot frequency 1 is normalized to 1, then at slot frequency of 5 it might be 0.7, and at slot frequency of 10 it might be 0.05. Nor does the distractibility curve need to be monotonic. It may well have several peaks and valleys. For example if the first slot frequency is going for $2.50, the 5th slot frequency might be $1.00, and the 10th slot frequency might be $0.10. Thus there is a wide variation, and therefore session depth is an extremely important dimension.

Now while we have used the example of the mrec on the same “webpage” the invention is not so limited, and in fact the mrec is an ad unit that may in fact be on different web pages.

What is to be appreciated is that session depth can be a very important factor in a rule set. Therefore if session depth as a dimension is dropped it is very likely that we will need to apply a correction factor to the resulting calculations to try and compensate for the lack of this dimension in the rule set. Now this correction factor can be derived from a historical perspective across for example campaigns and then adjusted by another correction rule and then applied. However, as noted above, the “historical correction rule” is just another rule set and is subject to the same testing for “believability” as any other factor. So for example, the historical correction rule might not be believable in which case the rule might be to discount it by a factor of two.

While the example of dropping session depth and correction has been discussed, the same correction approach can be applied to any dimension that is dropped. Again the believability can be tested and ultimately the best prediction and winner in a test will determine the winner in a competition.

Now the writing of the actual rule can be done in any language applicable. Simple If Then Else statements may be used for example, If the number of dimensions dropped is 3 And the correction factor is greater than 2 Then multiply by 0.05. So a Rete algorithm rule engine is one possible embodiment.

In one embodiment of the invention the correction factor is in the range of 0.05 to 1.0.

The cell should also contain a record of how it was calculated, how many dimensions were dropped, what was the time frame, etc. The idea is that we need transparency as to why the cell made the decisions that it made. In this way the user can see why the optimizer made the decisions it did.

For example if we look over a 24 hour period and see that we have 45 million impressions in the US and we see that 38 million of those impressions were run on cells that had no dimensions dropped, so there were no correction factors, that is very good. Assume we made $100K based on the 38 million impressions but $14K less than we predicted, so we're somewhat more optimistic than reality. So if we want to try and correct for the delta of $14K, it clearly has nothing to do with the correction factor (recall because there were no dropped dimensions and thus no correction factor was applied).

The correction factor is defined infra, however, the entire correction factor is generally between 0 and 20.

We need to write down all the ways that we made the calculation for the pRPM so that after the algo runs the user can look at it for ideas on how to improve it. That is how and why the algo was making the various serving decisions. That is, why it did what it did and how can we make it better. The decisions are based on the rule sets, but how did they perform in real life? Well if 38/45 million impressions (or about 84% of the time) did not need to drop a dimension, then that tells the user that there was sufficient believable data and therefore dropping of dimensions was not an issue and therefore is unlikely to be a factor in trying to improve performance. So based on this the user might think that adding a dimension might allow for improvement. So the user introduces, for example, the dimension of age. Conversely the user could look at the performance based on a time period for clues. For example if the accuracy of the prediction is 88% over a 24 hour period but drops to 77% over a 3 day period and to 70% over a 7 day period then the user knows the time period affects the accuracy. The user may try and see if time segments in the 24 hour period are more accurate than others and use this to improve the bottom line. That is let the rule sets compete in this case, the control at say 24 hours against others that have a shorter time period.

Now if the business model happens to be a CPM then there is absolute certainty on how much we are getting paid and there is no need for predictions, however, there is no upside and the “risk” in the CPM model is passed to the advertiser. Currently most ad networks are the CPM model, and they need to build large sales staffs to sell the advertising.

So if we are running both a CPM campaign and a CPA campaign for example, then the user may adjust the rule sets to account for the CPM (where the prediction is not needed and is 100% accurate), by tweaking for example, the CPC.

Okay we are largely done discussing the dimension dropping.

Now on to the significance formula. We could write a really simple criterion rule, for example, If CPA campaign and the conversions are less than 10 then it's not significant Unless impressions are greater than 100,000. This simple formula has both positive and negative significance meaning we want to see at least 10 conversions (the positive significance) but if we've served 100,000 impressions then forget it (negative significance) as this campaign is not converting enough. Basically we're saying that if we see 10 or more conversions we believe the results and they are significant. We also believe the results (they're significant) if we have fewer than 10 conversion if we've served 100,000 impressions.

The objective is to populate each cell. We have our set of vectors, we start with the first vector and we get a number and we run our significance test and it passes or it fails. If it passes we do the next vector. If it fails we move to the next point on the vector (e.g. reducing dimension) and repeat the process till we have something significant. We do this for all the vectors and we have the cube built.

Now we're done building the cube, now we need to use it. We're not done with the rules yet. We ship the cube off to the machines that use it as fast as possible. Ideally we try and stream it. The first thing the machines do is they find the eligible campaigns. Next they go to the cube to get the pRPM, and send that to a secondary rule engine, and then they go to a learning engine. The secondary rule engine determines which campaign to select. The secondary rule engine gives weights or probabilities to campaigns based on what's in the cube.

For example assume we have two campaigns, one that came in at $1.00 and another at $0.99. The secondary rule engine may say give it a 60/40 traffic split for the $1/$0.99 campaigns because they are pretty close to each other. The rationale for this is that both the $1 and $0.99 are predictions and there is no proof yet that the $1 is actually better than the $0.99. Now the secondary rule engine should not only consider the pRPM but how the pRPM got there. For example if one of the pRPMs got there without dropping any dimensions and the other got there by dropping dimensions (which tends to indicate not sufficient/significant data), then arguably the one that dropped no dimensions is likely to be more accurate. Likewise for example, assume that one campaign came in at $10 and the other came in at $1. However, the $10 campaign came in with a low certainty like 14 days, lots of dropped dimensions, and large correction factors. Under these conditions, even though it's a winner the user in designing the algo may decide to limit the $10 campaign to 25% and give 75% to the $1 campaign.

The algo in one embodiment of the invention is comprised of multiple parts a) the vector, b) the significance rule, c) the secondary engine, d) etc.

The secondary rule engine takes the predictions as inputs and outputs percentages. The secondary rule engine also consults the learning engine.

Now if all the campaigns were running for a long time there would be no need for a learning engine. However new campaigns and advertisers come in all the time. If you run these new ones through the prediction engine their prediction will be zero because there is no history or actual data and therefore they would never be served up and would never get any traffic because they are new. That is, while we can make predictions by dropping dimensions, even with this each campaign comes in after the dimensions because for each cell it is composed of each campaign, and for a new campaign with no actual data the prediction will be zero. Thus the need for the learning engine.

We need to test the new campaign somehow. Realize that because it is new and we have no real data on it, that in essence to test it, we must expend funds with no idea of its actual return, that is we have to subsidize its testing. That is what the learning engine is for.

In one embodiment of the invention, the learning engine works by modeling the new campaign by looking at prior campaigns and applying a learning factor. For example, the learning engine would look at current campaigns 1 through 4 and say “I'm going to model the new campaign on 70% of the average of campaigns 1 through 4” (i.e. 0.7×(campaign 1+campaign 2+campaign 3+campaign 4)/4). Thus the modeling in this case is looking at a basket of campaigns and subsidizing the new campaign based on the basket. Note that in one embodiment of the invention the basket of campaigns used for modeling the subsidy (the learning subsidy) is determined to be similar to the new campaign. That is for example, if the new campaign is for socks, the basket may contain other campaigns for clothes such as pants, shirts, belts, shoes, etc. but is very unlikely to contain campaigns for archery, motor oil, cars, power tools, pool covers, etc. Now the learning factor can be greater or less than one. That is it might be 0.5 or 2.0, etc.

The basket, in one embodiment of the invention, serves an additional purpose—that of providing an idea where the new campaign should be placed. Again continuing with the sock example, it makes sense that where the shoe ads are being placed may be a more appropriate location for socks and more likely successful than the location for motor oil.

While the learning factor above has been discussed as a factor across an aggregate average of all modeled basket campaigns, the invention is not so limited. In one embodiment of the invention, each modeled basket campaign has its own learning factor weighting. For example, the model for the new campaign might be 0.7×campaign 1+0.45×campaign 2+1.34×campaign 3+0.17×campaign 4. That is a learning factor weight is given to each modeled campaign in the basket. In this way weights may account for believability, similarity, etc. For example, continuing with the socks example, a higher weight might be given to a campaign for shoes because socks are used with shoes than to a hat campaign.

In one embodiment of the invention the actual first step in the learning engine is to see if the campaign needs to be subsidized at all. That is, the optimizer might actually have a position on this issue, such as I know about this campaign. So the learning engine has a rule that describes what it means to be learned. For example, if after a campaign run we find that zero dimensions are dropped then the campaign can be considered learned.

In one embodiment of the invention there are learning limits. For example, it makes no sense to lose money subsidizing a campaign forever, so an upper spending limit on subsidy makes sense, for example do not spend more than $200, or more than $200 of opportunity cost. Likewise, a subsidy is no longer needed if the campaign is learned and/or can pay for itself. Similarly, resources are wasted if a campaign is taking too long to learn even if it is within budget, or the believability of what is being learned is low. Another possible learning control is to limit the learning to a time period. For example, stop learning after 24 hours, stop learning on Apr. 1, 2011, etc.

The learning engine, in one embodiment, checks to see that the campaign being modeled is enrolled in the learning engine, has not exceeded any learning limits, is based on a basket model, etc.

What is to be appreciated is that as a new campaign or a subsidized campaign is run the cube is updated based on real time results. That is learning is a dynamic process in real time, it is not static. This is done because it is very important to determine as quickly as possible if a new campaign has been learned (for example no dropped dimensions) or hit a learning limit (for example subsidy limit hit) because we are spending real money in real time and we need to minimize this expense.

For example, starting out at 0% learned it's possible that in a few minutes of running a campaign that we could be at 100% learned. We would then want to stop the subsidy whether or not the campaign is a winner. After the campaign is learned we have enough information to then decide separately whether we should use the campaign or not as it's now just another campaign in the cube and can compete with the others based on the techniques described. It is possible that it hit a learning limit and yet could compete successfully with other campaigns.

While we have discussed going from no learning (e.g. 0% learned) to fully learned (e.g. 100% learned), the invention is not so limited. For example the learning engine could look at the rate of learning and if the campaign is being learned very rapidly it could decide based on the believability of this to cut off the learning early to conserve subsidies.

For example, in one embodiment of the invention, the number of dropped dimensions could be the criteria for being learned. We have talked about no dropped dimensions being 100% learned, which is a simple example. However, the invention is not so limited and “learned” could also be something like only 10% of the dimensions have been dropped, or only 2 dimensions have been dropped, or dropped dimensions are being decreased at a believable rate to achieve 90% of the dimensions within the next 10 minutes, and so it can be considered learned.

When a campaign has been learned, in essence, it's stating that the cube has enough data about it that it can make a decision about it on its own. That is there is enough historically significant information for each cell that comes up that it has passed the learned rule. The newly learned campaign can now stand or fall on its own as it competes against other campaigns. That is, the optimizer can now work with it.

Note that the learning being disclosed here is not the advertiser funded learning budget approach such as a CPM campaign where the advertiser pays to have a campaign run, after it is run, then gets the results and then possibly runs another campaign.

As noted above one of the possible learning limits is based on a dollar limit (hard cost), and another is based on opportunity cost. It is important to understand the distinction because they are not the same. A dollar limit or hard cost is what it costs for us to pay for impressions, etc. in order to learn. These are hard costs for example, for slots, etc. They are irrespective of what we place there and therefore fixed costs. They are always positive, meaning we are paying money. Opportunity costs are what we stand to lose or gain versus something else that could have been taking place instead of the learning. So for example, suppose we are running a campaign 43 which is netting us say $1 per impression. We now substitute a learning campaign into the slots, placements, etc. that campaign 43 was formerly running and the learning campaign is netting us $0.80 per impression, then we are losing $0.20 for every impression, so our opportunity cost is $0.20 per impression (i.e. a negative number compared to campaign 43). On the other hand, if the learning campaign is netting us $1.20 for every impression, then we are gaining $0.20 for every impression, so our opportunity cost is minus $0.20 per impression (i.e. a positive number compared to campaign 43). Clearly we are burning through a learning budget if we have lost opportunity costs, and funding a learning budget if we gain opportunity costs. In the case of continued lost opportunity costs we will deplete a learning budget and hit a limit. On the other hand if we are continually gaining opportunity costs and thus increasing the budget we will not run out of funds and some learning control limit, such as time, or if funding increases to some limit, etc., must be used to stop the learning.

Now when the learning is completed by either being learned or hitting a learning control limit the cell has the information on the campaign and the associated information (learned, hit a limit, not learned, etc.), and the believability (believable, not believable), etc., and can now be used by the optimizer to compete. It may well be that the optimizer does not pick this new campaign, however that is up to the optimizer. What is to be appreciated is that the new campaign has been subsidized to a given level (learned, hit subsidy limit, etc.) to give it a chance to compete with other campaigns.

The significance test can be as simple as noted above where the example was If CPA campaign and the conversions are less than 10 then it's not significant Unless impressions are greater than 100,000. Or the significance test can be a statistical test such as a two-tailed Z test, etc.

In one embodiment of the invention different cubes are launched and are running at different and possibly concurrent times and/or overlapping times. Thus each cube has time data associated with it, for example start time. That is, for example, cube #3 could start at 0300 and finish at 0700, cube #27 could start at 0230 and end at 0600, cube #4 could start at 0100 and end at 1200, cube #32 could start at 0900 and end at 1000, cube #99 starts as 0630 and ends at 0930, cube #104 starts at 0500 and ends at 1300, etc.

In one embodiment of the invention a universal placement server is used, for among other things, serving up the A/B test. The universal placement server is a machine that allows you to take any traffic anywhere, split it by any kind of rule, and measure the results. This allows for optimization.

Now in one embodiment of the invention, after picking the campaign, by using the campaign/inventory optimizer and the learning engine, the presentation of the actual creative can be optimized (i.e. creative optimization), as well as the offer (the offer is on a landing page and so landing page is understood to refer to the offer and vice versa) or landing page. In one embodiment of the invention, landing page optimization is similar to creative optimization but we're applying optimization to landing pages rather than ads. In one embodiment of the invention, after a conversion there are product and email optimization, i.e. post conversion optimization or post landing page optimization.

In one embodiment of the invention, the universal placement server let's you take any piece of traffic coming in and create as many optimization points as you like. So these are placements or placement tests that can be modeled.

In one embodiment of the invention, the placements can be modeled it as comprised of a slot, which goes into a rotation, rules which have campaigns, which have locations of ads, which has an ad, which has a piece of content as an asset, which takes you to a landing page, and sells you a product. So we've taken one interaction and made a series of placements. Now we can describe how traffic flows from one placement to the others. We get to measure it and then we can answer the question how did a slot do compared to a control on, for example, conversions? Or how did this campaign do against a target? Or how did this ad do against my target? Or how did this asset perform against my target, etc.? This allows us to try to optimize it.

A screen shot of the universal placement server may be seen in FIG. 57 and FIG. 58. FIG. 57 shows how you went into slot rotations. So you are describing how traffic flows, for example, under these conditions go 100% of the time here, under these conditions go here, under these go here, etc., etc., etc. FIG. 56 also shows the universal placement server. Where for example, in this country send 95% of the traffic this way, 5% this way, and 0% this way. FIG. 54 also shows the universal placement server, as does FIG. 53, FIG. 52, and FIG. 51.

In one embodiment of the invention, the universal placement server knows about traffic, ads, results, publisher, slots, as well as landing pages, campaigns, assets, rotation of campaigns, etc.

In one embodiment of the invention, the universal placement server does deploying, and rotating, and tracking, and reporting, and can roll back for not only ads but anything else. both visible and not visible. For example whether that thing is an ad, or a headline within an ad, or a landing page, or a product bundle, or a trafficking rule set (which is not visible to the eye), in other words any asset.

So in one embodiment of the invention, for example, we can create placements, for example, 5 trafficking rule sets and attach them to placements in the universal placement server and deploy them and rotate them, report about them, etc. and then see for example, that rule set 4 is producing more revenue than rule set 3.

In one embodiment of the invention, the universal placement server is able to track actions, etc., based on an ad tag being invoked by a browser. When that ad tag is invoked by a browser things can happen that allow the universal placement server to take measurements, get results, etc.

In one embodiment of the invention, the universal placement server is capable of driving traffic through a website using open ended rules, and measure the result of who looked at it, what the piece of content was as against your objective, etc.

There have been many technologies for getting content in front of people and even measuring when people have looked at that content. For example Google Analytics. That's easy. The trick which the universal placement server does is to get lots of variants and test against each other against a goal. You must put out multiple versions of the same thing and Google Analytics can't do this. Nor can you just serve up multiple pages because you have to solve the traffic problem. We control the traffic by writing a rule for a rule engine like If Then Else and then at the final point a percentage split of the traffic, and it's recursive. So, for example, you can say, “first split traffic by country, then for each country split the traffic by gender, and for gender let's do an 80/10/10 split (80% male, 10% female, 10% unknown) against these campaigns”. Now as for feedback, each time there is a placement it's measurable, for example, in the star schema against the end result that you are looking for. Thus the feedback is causal.

That is you can know for example, who viewed something and later signed up as a result of the viewing. We do this by putting each experience into a transaction and we can see the transaction from front to back. How we do this is by making a placement. There are two types of placements. Those that result in other placements, and those that render a piece of content. If it renders a piece of content it required user interaction (e.g. the result of a click or navigation, for example to another page).

Now an ad rotation just renders from an ad, whereas an ad renders a piece of content, user interacts with it and goes onto a landing page. Then there may be a landing page rotation. So there are several pieces.

Then you need a rule engine that drives the content through. Then you need to measure causality. The way we measure causality is that the very very first placement that the user encounters in this chain starts a transaction. After this every other placement that the user encounters is allocated on that transaction. For example, it may be allocated based on a timeline of the transaction. For example, some users may not get beyond seeing the ad. Some users may get from the ad to a landing page. Some users get from the ad to the landing page to the click (for conversion).

Because we have the transaction we have the causality between the conversion and the landing page and the ad. And we have other things such as the asset use on the ad, etc. This is all lined up against the same transaction. We put this into, for example, a star schema and we can begin counting them. Then we can determine such things as, for example, for these conversions 50% came from males, 30% from females, and 20% from unknowns. Also we can determine, for example in the same conversions, that 80% of the impressions came from males. This gives us information that the remaining 20% impressions converted at a higher percentage rate than males (i.e. for 80% of the impressions, males only converted 50% of the time, whereas for 20% females and unknowns converted also 50% of the time, thus fewer impressions were needed for the same number of conversions for females and unknowns).

Now the ability to rollback may be needed, for example, if a landing page is performing badly. We would simply rollback and try another landing page. Additionally, from the timeline of the transaction there is the ability to not only rollback but to also rollforward.

Thus the universal placement server allows for the gathering of information on which we can also perform optimizations.

More Details

In one embodiment of the invention the system or machine may be considered to be comprised of multiple sequential gates. Each gate represents a decision that must be made. Each gate is sequential to the previous gates in time. A visitor may enter the machine at any gate, but entering through any other than the 1st gate requires that the appropriate decisions be made external to the machine. We can see the act of passing each gate as reducing a degree of freedom possible in interacting with this specific visitor for this specific transaction.

Each “visitor” is our representation of a distinct human being who is potentially capable of becoming a customer for one or more of our advertisers. We interact with visitors in sessions, and in transactions. Each pass through Gate 1 starts a new transaction. Each session is started by standard browser mechanisms.

Gate 1: Select Campaign
1.1 Entry to Gate 1 is initiated with a receipt of an ad impression opportunity. This may be one of two types
   1.1.1 Bid opportunity. The ad impression is not yet committed to us. We first need to present a dCPM (dynamic cost per 1K impressions) bid to the real time bid exchange (RTBx). If the bid is successful the impression is commented to us. In this case we need to use the campaign/inventory optimization engine to find the campaign likely to yield the highest revenue for us and to submit the associated CPM (cost per thousand impressions) (intersection of this campaign with the cells in the cube representing this impression) to the RTBx.
   1.1.2 Committed Impression. In this case, we do not need to bid on this impression separately. It is already committed to us because there exists an a-priori agreement with the publisher. The agreement may be based on static CPM or eCPM (effective CPM) defined a-postiori by other events. In either case, the subsequent mechanics are the same as the RTBx case, except we do not need to publish the dCPM estimate/bid to anybody else.
1.2 The next step is to assemble whatever information we have about this user/session/transaction in order to disaggregate it from other impression opportunities. This is done by reading the data from a virtual “Visitor Data Store” (hence VisitorDB), such as Patent Application Publication Number: US 2002/0174094 A1 to create a virtual data store that has visitor information. There are in fact 3 separate and distributed sources of data which are combined to create an abstracted VisitorDB. The VisitorDB must return data within 100 milliseconds. Any longer and there will not be time to process the RTB request or the ad will be delayed in a monetarily significant way. To this end the immediate data stores are prioritized over the persistent store. The 3 data stores are:
   Brower Cookies. We store information about this visitor is encrypted cookies in his browser. This forms a very efficient and highly distributed database, where each visitor bring along his own information about who he is, how many and what ads and campaigns he has seen before, what he has purchased or clicked on before, what targeting vectors exist to describe him and so on. While a highly efficient mechanism, cookies are not accessible in RTBs
   Publisher provided data. Publishers sometimes provide data about the user. This often includes data not available to anyone else. Such as user age and gender. User interests and so on. When provided it is copied into the distributed visitor database (DVDB) for further use and cross referenced to the publisher ID for this user (each publisher has a separate system of assigning unique IDs to the user, we can simply this to a vector on n-unique 128 bit GUIDs, one for each publisher). Sometimes the data is provided by the publisher explicitly (as parameters) and sometimes implicitly. If implicitly (i.e. the ad buy is parameterized only a certain user demographic) the Demographics Data Enrichment Service translates the ad buy into standard user characteristics.
   Distributed DB (DVDB). The DVDB data store is the only one to be guaranteed to be persistent. However, as it is very hard to assure scalable performance for our scale (400+ million unique visitors) at the 100 millisecond timeout, it is supplemented by the other stores. The DVDB is implemented as replicated multi-node NON SQL database similar to Apache Cassandra. The data is automatically replicated to multiple nodes for fault-tolerance, and each node is physically close to each ad server. Failed nodes are bypassed and requests proxied to live nodes, while the failures are repaired.
1.3 In parallel to the user/session/transaction is retrieval from VisitorDB, a frequency counter cache (FCC) is established. We can conceptually think of this as part of the VisitorDB, but for performance reasons it is a separate implementation. Once again it uses either browser cookies or a very high speed memory data store (like memcache) to keep a counter of how many times the user has seen this slot (and this campaign, and this ad rotation, etc. . . . ) in the last X hours (typically 24 hours). In the RTBx case this is critical information to have that is not provided by the largest exchanges such as the Google AdX. Because display advertising is all about distracting the user from what he is doing on the web site, the first impression is significantly more valuable than the second. The 10^{th} impression may be worth only as much as 1/100^{th} of the 1^{st}. We cannot bid on the blended average. If we did so, we would wind up underbidding the 1^{st} and overbidding the rest. Therefore a FCC is required to track all bid opportunities, not simply the ones where we bid or the ones where we win. Once connected to the RTB bid flow it must keep a running frequency of all visitor/slot combinations.
1.4 VisotorDB data is supplemented by a series of translation services. These translate one piece of visitor data into other pieces of data that are more actionable for targeting purposes. Translation services include
   1.4.1 Geo Service: This translates the visitors IP address into country, MSA (metro service area), city, state, ZIP and lat/long centroids.
   1.4.2 User Agent Service: This translated the header information presented by the browser into OS, Browser Type, Browser User Language.
1.4.3 Language Service: Translates GEO and Browser Language into the language we think the user prefers.
1.4.4 Demographics Data Enrichment Service: Translates GEO into standard demographic data (available from the census bureau or from 3^{rd} parties) such as average Age, Income, Education Level, Demo Profile. This is then merged with any specific demo data available on the user profile. The service is also responsible for mapping specific ad buys where demographic data is available as part of the targeting criteria (e.g. Facebook direct) to permanent storage in the VisitorDB (including cookies).
1.4.5 Targeting Vector Service: The visitor may belong to one or more “standing” targeting vectors, meaning that an advertiser would like to target or exclude the visitor specifically (remarketing based on prior behavior, or exclusion if already a customer)
1.5 After the VisitorDB and FCC data has been retrieved, processing is passed to the trafficking engine. The trafficking engine provides a way to define rules that drive traffic. The rules can be applied left to right (literally defined how traffic flows) or right to left (by placement eligibility). The rule engine can implement manual learning and other exceptions.
1.6 All eligible campaign placements or optimizer placements are determined. Eligibility is based on targeting rules
1.7 Eligible campaigns are compared against the list of temporarily ineligible campaigns broadcast by the campaign controller. The campaign controller is implemented as a series of independent nodes that maintain aggregate stats on the campaign level in near real time. They broadcast STOP requests to all ad servers via a message queue. They also broadcast PACING instructions. The reasons a campaign needs to stop are as follows
   1.7.1 Daily Budget Spent
   1.7.2 Lifetime Budget Spent
   1.7.3 Pacing to normalize spend through the day (to hit budget goal)
   1.7.4 Pacing to maximize revenue (by setting the CPM floor)
   1.7.5 Campaign is CPA, and advertiser (pixel) outage is detected, following algorithm
      Get campaign Impression and Conversions as records in 10 minute intervals
      Check if the current last record's conversion value is 0. If not—the campaign is not faulty
      Going up from the last record (which conversion value is 0). Looking for the border (the first record that has conversion value not 0).
      If the border found—begin calculating Sigma and Confidence for records up and down from the border. The impressions and conversions (for Sigma calculation) are summarized accordingly for upper (good) and lower (bad) steps.
      If Sigma is more or equal of 3 (i.e. over 99% confident) AND bad impressions quantity is not less than a half of good impressions AND the campaign is not paused—campaign is faulty

We define Sigma as (r1/n1)−(r2/n2)/sqrt[{((r1/n1*(1−r1/n1))/(n1−1)*(1−(r1/n1*(1−r1/n1))/(n1−1)))/(n1−1)}+{((r2/n2*(1−r2/n2))/(n2−1)*(1−(r2/n2*(1−r2/n2))/(n2−1)))/(n2−1)}]
Where
   if n1=impressions[1]; were [U] denotes cell U
   if n2=impressions[2]
   if r1=conversions[1] if CPA or clicks[1] if CPC
   if r2=conversions[2] if CPA or clicks[1] if CPC
Explanation
   let dp1=(r1/n1*(1−r1/n1)/(n1−1)
   let dp2=(r2/n2*(1−r2/n2)/(n2−1)
   let dd1=(dp1*(1−dp1)/(n1−1)
   let dd2=(dp2*(1−dp2)/(n2−1)
   let denom=sqrt(dd1+dd2)
   then sigma=abs((p1−p2)/denom)
using the z-test, if NORMSDIST Returns the standard normal cumulative distribution then confidence (0-99.999x %) is defined as the NORMSDIST(sigma)−NORMSDIST(−sigma)
1.7.6 Pacing Controller broadcasts pacing instructions. It measures the amount of budget currently spent against elapsed time (assuming a daily budget cap) and then gives out a percentage at which the ad-server can serve (1-100%) that campaign. It then sets a CPM floor against which pRPM is measured. The floor is calculated by setting a floor and looking at the historical performance. If the floor was not enough to spend the daily budget, then the next day the floor is incremented. This assures that the limited number of campaign impressions are spent only in those slots where the end results (the RPM) is highest. This ensured higher overall monetization for the network. Put plainly, the idea is that scarce campaign impressions are saved for those slots where we make the most money.
1.7.7 A campaign is deemed not-eligible if it does not have any eligible creatives (as a single campaign can have creatives serving multiple sizes or publisher requirements). Creatives each have their own eligibility rules (by size, by what the publisher allows (e.g. animation, content, sounds, etc)). These rules need to be checked before a campaign is selected, otherwise it is possible to select a campaign that has no eligible creatives (forcing backtracking, which is not efficient).
1.8 Eventually eligible traffic is sent to one or more (typically more than one, based on rules or random weights) placements representing different configuration of the campaign/inventory optimizer. Each configuration has its own data cube, and its own set of auction rules. These placements compete with each other over time. Those with higher RPMs are promoted, the others discarded.
   1.8.1 Typically an single optimizer placement can manage not only campaigns but other optimizer placements. To the cube they look the same (each has a pRPM for any given set of dimensions)
   1.8.2 The cube is described by rules to contain the dimensions this particular optimizer placement will pay attention to (including both data and time dimensions) plus rules as to what is considered significant and how to aggregate data “up”.
      1.8.2.1 Need to describe in more detail, but this is covered pretty well in the prelim patent
      1.8.2.2 Each campaign placement (or another optimizer placement) has an entry in the cube for each cell (where the cell is defined based on the data above). The job of the optimizer is to pick the placement predicted to perform the best (within a given range and confidence interval). It does so as follows by looking a two tailed distribution between each campaign:

m=(x_{—}1+ . . . +x_{—}N)/N

s2={(x_{—}1−m)̂2++(x_{—}N−m)̂2}/(N−1)

T=(mu−m)/{s/sqrt(N)}
Note: the sample mean m from a normally distributed sample is also normally distributed, with the same expectation mu, but with standard error sigma/sqrt(N); By standardizing, one gets a random variable T
The random variable Z is dependent on the parameter mu to be estimated, but with a standard normal distribution independent of the parameter mu
Hence it is possible to find numbers −z and z, independent of mu, where Z lies in between with probability beta=1−alpha, a measure of how confident we want to be.

Pr(−z<T<z)=beta
Where beta is say 95%

Pr(m−z*s/sqrt(N)<mu<m+z*s/sqrt(N))=beta

z=Fi−1{Fi(z)}=Fi−1{1−apha/2}
Where alpha is say 5%
The number z follows from the cumulative distribution function:

Fi(z)=P(T<=z)=1−alpha/2

N=(z*s/m_int_half)̂2
However, the above hypotheses, in general, constitute a single-tailed test.
“For two samples, each randomly drawn from a normally distributed source population, the difference between the means of the two samples, m_{—}1−m_{—}2 belongs to a sampling distribution that is normal in form, with an overall mean equal to the difference between the means of the two source populations mu=mu_{—}1−mu_{—}2.
The null hypothesis, then mu<=0” “If we knew the variance of the source population, we would then be able to calculate the standard deviation of the sampling distribution (“ ”standard error””) of sample-mean differences as

SE=sqrt(stdiv̂2/N_{—}1+stdiv̂2/N_{—}2)
This, in turn, would allow us to test the null hypothesis for any particular m_{—}2−m_{—}1 difference by calculating the appropriate z-ratio

z=(m_{—}1−m_{—}2)/SE
and referring the result to the unit normal distribution.
Since the variance of the source population is unknown, the value of SE can be arrived at only through estimation. In these cases the test of the null hypothesis is performed not with z but with t:

t=(m_{—}1−m_{—}2)/estSE and estSE=sqrt{(s_{—}1)̂2/N_{—}1+(s_{—}2)̂2/N_{—}2}
The resulting value belongs to the particular sampling distribution of t that is defined by

df={(s_{—}1)̂2/N_{—}1+(s_{—}2)̂2/N_{—}2}̂2/{((s_{—}1)̂2/N_{—}1)̂2/(N_{—}1−1)+((s_{—}2)̂2/N_{—}2)̂2/(N_{—}2−1)}
If equal variances are assumed, then the formula reduces to:

estSE=sqrt{s2/N_{—}1+s2/N_{—}2}

and

s2={(N_{—}1−1)*(s_{—}1)̂2+(N_{—}2−2)*(s_{—}2)̂2}/{(N_{—}1−1)+(N_{—}2−1)}
The resulting value belongs to the particular sampling distribution of t that is defined by df=(N−1-1)+(N_{—}2−1).
1.8.3 Once the winner is selected, control is passed to the learning engine. The learning engine sees if a substitution to the winning campaign is necessary. The substitution is based on the need to learn to see how new campaigns will perform. A new campaign is mapped to a weight adjusted bucket of existing campaigns. It can serve instead of the winning campaign based on the weights assigned until learning is turned off. Learning is defined OFF if the opportunity costs for this campaign is exceeded, or its learning impression budget is exceed or it is in fact learned at the given cell (i.e. it was considered by the optimizer and either selected as a winner or discarded on its own merits).
1.9 The winning campaign is selected as the outcome of Gate1. A bid CPM associated with this campaign is retrieved from a cube representing the bid-dimensions. In RTBx case the bid CPM is transmitted to the exchange.
1.10 Skip to Gate 2, but logically the next step is: The content of the transaction is written out to the Measurement Service. The transaction is represented in 5 parts
   1.10.1 The nature of the inventory (publisher, slot, geography)
   1.10.2 The nature of the visitor (frequency, gender, age, browser, targeting vectors)
   1.10.3 The winning placements
   1.10.4 The reasons why the optimizer selected this placement (learning engine override or not, how many campaigns participated, expected RPM, winning RPM, etc. . . . )
   1.10.5 Additional known Sub IDs
1.11 The following events and financials are written out to the Measurement Service.

Bid Request. Bid Response (CPM). Bid Won (price, in case of 2^{nd} price auction), Impression (cost). Impression Load (time to load, goes into the transaction definition as Ad Load Time).

Gate 2: Select Ad

Typically, there is a real-time transition between Gate1 and Gate2 inside the same machine. However, under a number of circumstances, we can enter the machine directly trough Gate 2. This happens any time where we are allowed to serve, but must buy against a specific campaign (e.g. in Advertising.com, Yahoo Yield Manager or MSN). In those cases, the 3^{rd} party's ad server sells us a campaign but the creative is defined as our ad call tag.
2.1 All creatives associated with a campaign are done so indirectly through a product. A campaign promotes a specific product at a specific price/terms/targeting combination. Creatives promote that product irrespective of the campaign specifics. Rather creatives are organized by product, user language and size (“size” is really a description of physical attributes, so movies can be represented as having size “movie-30 seconds” and banners can be represented as “728×90”—the key is that the size of the creative match what is accepted by the slot).
2.2 Creatives are further organized into “rotations”. A single rotation contains creatives (at the same level of product/language/size) that can compete against each other. Creatives are marked according to whether they are testing a new concept (concept) or a new variation on an existing concept (variant).
2.3 Within a single rotations, ads are run randomly (with weights provided by the system or the marketing analyst) for each tier in the ad rotation frequency.
   2.3.1 When the system has enough information to say with statistical confidence of σ>3 or 99% that a given ad variant performs worse than the leader (control), it deactivates that variant from the rotation. The performance is measured on net yield (conversion/impressions) using the formula (r1/n1)−(r2/n2)/sqrt[{((r1/n1*(1−r1/n1))/(n1−1)*(1−(r1/n1*(1−r1/n1))/(n1−1)))/(n1−1)}+{((r2/n2*(1−r2/n2))/(n2−1)*(1−(r2/n2*(1−r2/n2))/(n2−1)))/(n2−1)}] if the product prompted is priced CPA and on click yield if it priced CPC (in that case C=Click rather than conversion).
   2.3.2 The creative marketing analyst in charge of the rotation is notified when the ad is deactivated. When there are no ads remaining in the rotation, the creative marketing analyst is required to refill the rotation with new ideas to test
   2.3.2. Each variant has a test-reason associated with it (e.g. “testing headline FREE versus COMPLIMENTARY”). The reason associated with the winning variant is recorded. The marketing analyst is then prompted to perform this test on rotations where this particular reasons has not been tried yet
   2.3.3 Concepts are archived for future resting. A small percentage of traffic (analyst controlled) is allocated to retest older concepts.
2.4 Ads are checked for eligibility. Ineligible ads are discarded. If no ads are eligible, the campaign in question is also not eligible.
2.5 The system is provided with a set of potential cube-dimensions in which the ads may behave differently. Typically one set of dimensions involves the nature of the inventory (slot/site/publisher) and other involves how distractible the user is (rotation-frequency or slot-frequency). The system then tests if the winning ad behaves the same in each of the cube dimensions. If different cells in the cube have different winners, the system will repeat 2.3.1 for each SET OF CELLS (rather than for the system overall).
   2.4.1 As long as there are non-trivial (revenue >X % of total) cells where the winner is not the same, the system will bifurcate the results presented to the marketing analyst in 2.3.2. For the marketing analyst these effectively become “sub-rotations” and can be managed separately.

Gate 3: Select LP

A landing page (LP) follows immediately after the click on the ad. The LP in fact represents an entire series of pages (or user experiences) that is presented to the user. There is a user initiated transition from the ad to LP1 and from LP1 to any subset discreet user experience (LP2, LP3, . . . LPn). The process of selecting the LP(x) is recursive, so we refer to the gate as selecting the LP we really mean a recursive selection of LP1, LP2, . . . LPn.

In one embodiment of the invention, selecting the LP may use the same approach as ad selection.

Gate 4: Select LP Exit/Cross Sell/Up-Sell

In one embodiment of the invention the LP exit may be optimized and cross sell and up sell opportunities are presented for further conversion possibilities.

In one embodiment of the invention, selecting the LP exit and cross sell and up sell may use the same approach as a campaign selection.

Gate 5: Select Product/Order Configuration

In one embodiment of the invention further selection of the product is possible as well as order configuration.
In one embodiment of the invention, selecting the product and order configuration may use the same approach as a campaign selection.

Gate 6: Select Email to Subscribers

In one embodiment of the invention the email is sent to subscribers based on rule sets for optimum follow up, etc. (e.g. not a time of month when rent is due).
In one embodiment of the invention, selecting who to email and when may use the same approach as ad selection.

Gate 7: Select Payment Option

In one embodiment of the invention the selections of payment options is presented. In one embodiment of the invention, selecting the payment option may use the same approach as a campaign selection.

Further Details

An embodiment of the invention is described below.
Collect actual data regarding visitors, traffic. Calculate revenue. Load into a DWH using a star-schema where each dimensions represents a facet of a cube.
Define a rule-set that you intend to test. The rule-set start with (a) vector of dimensions and (b) a significance test for deciding whether a given cell has data you intend to use/believe or not.
The dimension vector can be expressed using a shorthand notation that looks something like this

| Base Dimensions | Time Dimensions | Demographic Dimensions |
|---|---|---|
| Country | 24 hrs | Age |
| Slot Ad Size | 3 d | Gender |
| Platform | 5 d | |
| Publisher | 14 d | |
| Site | | |
| Slot | | |
| Session Depth | | |

This is really shorthand for the following vector
Country×Size×Platform×Publisher×Site×Slot×Session Depth×Age×Gender×24 hrs
Country×Size×Platform×Publisher×Site×Slot×Session Depth×Age×24 hrs
Country×Size×Platform×Publisher×Site×Slot×Session Depth×24 hrs
Country×Size×Platform×Publisher×Site×Slot×Session Depth×Age×Gender×3d
Etc. . . . .
   Each point in the vector indicates a combination of dimensions to calculate metrics from using a necessary correction factor. Note: that the points in a vector do not need to be consistent. For example, we may never want to drop Age as a dimension until we get to country. So the shorthand is provided only for convenience of notation, and is not a computational restriction.
   The next step is to use the data in the DWH and the vector definition to calculate a predictive cube. The cube is equal in dimension granularity to the maximum set of non-time dimensions. So in the example above each cell in the cube would have granularity of:
Country×Size×Platform×Publisher×Site×Slot×Session Depth×Age×Gender
   Each cell in the cube contains N entries corresponding to the number of campaigns you wish to optimize. So again, by example:
Country×Size×Platform×Publisher×Site×Slot×Session Depth×Age×Gender×Campaign 1
Country×Size×Platform×Publisher×Site×Slot×Session Depth×Age×Gender×Campaign 2
Country×Size×Platform×Publisher×Site×Slot×Session Depth×Age×Gender×Campaign 3
Country×Size×Platform×Publisher×Site×Slot×Session Depth×Age×Gender×Campaign 4
   The metrics for each entry in each cell contain the following
Number of impressions used for the prediction
Yield curve used for the prediction
Predicted RPM (which is defined as the Price*the Yield Curve)
   The Yield Curve expresses the ratio between what you pay for (impressions) and what you charge for (e.g. impressions, clicks, conversions, achievement levels, etc). In the industry some of these have standard names like CPM (impression), CPC (click), CPA (conversion) and others do not. By definition the CPM yield curve is 1. Typically we expect a yield curve to decline in order of magnitude the farther the revenue event is removed from the cost event. So by example
CPM 1
CPC 1/1000^{th}
CPA 1/10,000^{th}
Etc.
   By definition, the predicted RPM (pRPM) is equal to the Yield-Curve multiplied by the contractual payment unit price). NOTE: The price is always the current price, not the historical price. Likewise, only CPM pricing has pRPM known with 100% certainty. In all other instances you are guessing.
   When the value of a cell entry cannot be calculated directly from the most granular vector (because it fails to pass the significance threshold) it must be calculated from other less granular vector points. This may require a correction factor. The correction factor is defined as
Yield if the most granular cell (across all campaigns)
   Divided by
Yield of the lower granularity cell used to make the calculation (across all campaigns)
   Multiplied by
Rule-driven formula based on how much of a correction to apply
   The cell must also contain a record of how it was calculated. This is used to pass-back in serving logs and enters the DWH. This allows us to compare not only the discrepancy between predicted revenue and actual revenue, but the reasons behind the discrepancy (for example, are the correction factors not accurate enough, etc).
   The data in each cell is either something you choose to use or not. We call this the significance test. The significance test is written as a mathematical rule. It can be as simple as
If CPA campaign, and CONV<10 then FALSE, unless the Impressions >100,000
   In this example, we see both a positive significance test (conv<10) and a negative significance test (impressions >100,000). This is necessary so that the absence of a result, is something we can call significant—if we have tried the experiment enough times. The formula is likely to be written using statistical mathematics. See the footnote for an example¹.
   Now we have a predicted cube with detailed granularity. Each cell contains the pRPM for each campaign. This cube needs to be transported (streamed) to all of the ad-servers making serving decisions
   On each ad-server, each available impression is categorized according to the dimensions in the cube. Campaigns are narrowed down to the list of eligible campaigns.
   Eligible campaigns are passed first (a) the prediction cube to get pRPM then (b) through the secondary rule engine to determine which campaign to select and finally through (c) the learning engine to see if there are additional campaigns that are eligible to serve because they are in learning mode.
   The secondary rule-engine assigns weights (percent probabilities) to campaigns based on the pRPM and other data available in the cube. For example if one campaign has a pRPM of $1.00 and another of $0.99 the secondary rule engine may decide to split traffic 60/40 as the predictions are close. Likewise, if one is at $1.00 and the next one is at $0.10 the traffic split may be 100/0. Further, the rule engine must consider not only the pRPM but how confident the pRPM prediction is. Let us say the #1 campaign has a pRPM of $10.00 and the runner up only $1.00. However, the runner up was calculated with high certainty (no dropped dimensions 24 hrs) and the winner was predicted with low certainty (14d lots of dropped dimensions and large correction factors). Then it may choose the serve the winner at only 25% until more data is gathered.
   The learning engine has a separate model for subsidizing campaigns currently in learning mode. First, the learning engine may not need to be involved, if the given cell already contains “data we believe” for this campaign (i.e. is already learned). If it is not already learned, than it must check that (a) the campaign is enrolled in the learning engine and (b) that it has not exceeded the cost/time/risk criteria allocated to it for learning and (c) that it is based on a basket of model campaigns whose pRPM value is sufficient to participate in the secondary rule engine and (d) that the probability of showing a learning campaign is limited by a user defined governor.
   The learning engine assigns each campaign a model based on a basket of other campaigns. Using the model a Learning pRPM can be calculated. For example:

(pRPM(cmp1)*Weight(cmp1)+pRPM(cmpN)*Weight(cmpN))/N

The learning engine also assigns learning limits. For example, the opportunity cost of this campaign may not exceed $200. The opportunity cost is defined as the difference between the actual revenue earned in serving this campaign subtracted from the revenue we would have earned serving the non-learning-assisted winning campaign. As this number can be less than zero, it is set to zero if the revenue for this campaign exceeds that of the non-learning-assisted winning campaign.
The rule-set sets limits or a governor on the frequency with which learning-assisted campaigns may win the auction. For example, a rule may be set to say that no leaning-assisted campaign can win more than 25% of the time.

¹Each campaign placement (or another optimizer placement) has an entry in the cube for each cell (where the cell is defined based on the data above). The job of the optimizer is to pick the placement predicted to perform the best (within a given range and confidence interval). It does so as follows by looking a two tailed distribution between each campaign:

m=(x_{—}1++x_{—}N)/N

s2={(x_{—}1−m)̂2++(x_{—}N−m)̂2}/(N−1)

T=(mu−m)/{s/sqrt(N)}
Note: the sample mean m from a normally distributed sample is also normally distributed, with the same expectation mu, but with standard error sigma/sqrt(N); By standardizing, one gets a random variable T
The random variable Z is dependent on the parameter mu to be estimated, but with a standard normal distribution independent of the parameter mu
Hence it is possible to find numbers −z and z, independent of mu, where Z lies in between with probability beta=1−alpha, a measure of how confident we want to be.

Pr(−z<T<z)=beta
Where beta is say 95%

Pr(m−z*s/sqrt(N)<mu<m+z*s/sqrt(N))=beta

z=Fi−1{Fi(z)}=Fi−1{1−apha/2}
Where alpha is say 5%
The number z follows from the cumulative distribution function:

Fi(z)=P(T<=z)=1−alpha/2

N=(z*s/m_int_half)̂2

However, the above hypotheses, in general, constitute a single-tailed test.
“For two samples, each randomly drawn from a normally distributed source population, the difference between the means of the two samples, m_{—}1−m_{—}2 belongs to a sampling distribution that is normal in form, with an overall mean equal to the difference between the means of the two source populations mu=mu_{—}1−mu_{—}2.
The null hypothesis, then mu<=0” “If we knew the variance of the source population, we would then be able to calculate the standard deviation of the sampling distribution (“ ”standard error““) of sample-mean differences as

SE=sqrt(stdiv̂2/N_{—}1+stdiv̂2/N_{—}2)

This, in turn, would allow us to test the null hypothesis for any particular m_{—}2−m_{—}1 difference by calculating the appropriate z-ratio

z=(m_{—}1−m_{—}2)/SE

and referring the result to the unit normal distribution.
Since the variance of the source population is unknown, the value of SE can be arrived at only through estimation. In these cases the test of the null hypothesis is performed not with z but with t:

t=(m_{—}1−m_{—}2)/estSE and estSE=sqrt{(s_{—}1)̂2/N_{—}1+(s_{—}2)̂2/N_{—}2}

The resulting value belongs to the particular sampling distribution of t that is defined by

df={(s_{—}1)̂2/N_{—}1+(s_{—}2)̂2/N_{—}2}̂2/{((s_{—}1)̂2/N_{—}1)̂2/(N_{—}1−1)+((s_{—}2)̂2/N_{—}2)̂2/(N_{—}2−1)}

If equal variances are assumed, then the formula reduces to:

estSE=sqrt{s2/N_{—}1+s2/N_{—}2}

and

s2={(N_{—}1−1)*(s_{—}1)̂2+(N_{—}2−2)*(s_{—}2)̂2}/{(N_{—}1−1)+(N_{—}2−1)}

The resulting value belongs to the particular sampling distribution of t that is defined by

df=(N-1−1)+(N_{—}2−1).

Optimizer Placement

Each campaign placement (or another optimizer placement) has an entry in the cube for each cell (where the cell is defined based on the data above). The job of the optimizer is to pick the placement predicted to perform the best, within a given range and confidence interval. It does this through a combination of ranking and statistical analysis to arrive at an answer for each serving decision.
For each campaign, define the vector Y, that contains N samples of the hourly RPM (Revenue per 1000 impressions) yields within the cell. This can be described as:
Y=[Y₁, Y₂, Y₃ . . . Y_{N-1}, Y_{N}], where Y₁ is the RPM in the first hour, Y₂ is the RPM in the second hour, etc.
For each pair of campaigns, define the vector D such that D=Y_{cmp1}−Y_{cmp2}. That is, the vector D is the difference in yields between any two campaigns in the cell over a given time interval.
A Z test is used to compare the results of D against the null hypothesis μ₀=0, using the standard method for calculating a z-statistic:

$$Z = \frac{D\_avg - μ 0}{3 / √ N}$$

Where D_avg is the mean of the vector D;
μ₀ is the null hypothesis;
N is the sample size;
s is the standard error of D

$$where s = \sqrt{\frac{1}{N - 1} {\sum }_{i = 1}^{N} {( Di - {D}_{avg} )}^{2}} .$$

The resulting Z-statistic is then be referenced by a Z table to give a probability. This probability indicates the confidence level at which the two campaigns' yields will differ. This probability is fed into the weights engine of the optimizer, where it uses this probability as the basis for the making serving decisions.
The weights engine uses a predefined set of thresholds to set serving weights of campaigns based on their probabilities of the yields differing. The actual weights and thresholds are user defined and can vary. If the probability that the yields differ is high, then the higher yielding campaign will be shown with greater frequency over the lower yielding campaign. If the probability that the campaigns' yields vary is much lower, then the two campaigns will be shown a relatively equal percentage of the time instead, representing the uncertainty over which campaign is actually the higher yielding placement.

More Details—Universal Placement Server

The Universal Placement Server is designed to (a) segment traffic and (b) render content across a (c) series of events. This involves the decisions by both the rule engine and the visitor. Decisions by the rule-engine are called “placements”. Decisions by the visitor or any other 3rd party are called “events”.
There are two types of placements.
Placements that segment traffic (e.g. slot, rotation, campaign, ad rotation)
Placements that render content (e.g. ad, ad asset, landing page, etc).
   The objective of the Universal Placement Server is to maximize the number (monetary value) of late-stage events (e.g. conversions, purchases) as a fraction of the number (cost) of up front events (e.g. bid opportunities, ad impressions).
   First step is to enumerate all of the possible placements types.
   Starting with the most “upfront” placement type (e.g. a slot) define a placement instance (e.g. slot1245).
   For each instance define traffic rules that send/split traffic from one placement to the next (e.g. from slot to campaign-rotation). These rules are either (a) declarative (e.g. if country is US then go to rotation1 else rotation 2) or (b) randomized weights (e.g. send 30% to rotation1, 40% to rotation2 and 30% to rotation3). These types of rules can be combined.
   The rules form an assignment equation

Rotation1→Rotation2

The rules may be expressed from either side of the equation
LEFT: “slot1 SEND traffic to rotation1 if country is US”
RIGHT: “rotation1 is eligible only if traffic is coming from country US”
   Once a decision is made (i.e. once traffic “goes through” a placement) that placement is recorded and is measured against the final results. This allows the system to see if there is a cause and effect relationship between the rule and the result.
   The data is visualized in a pivot table paradigm. This paradigm is seen as having two axis. The “X-Axis” is comprised of metrics. They “Y-Axis” is comprised of dimensions. Metrics are always represented as counts, dollars or calculations based on counts/dollars. The dimensions are always arrays of (typically string) scalar values.
   The log is likewise divided into two types of data elements. It is contrised of
Transaction-Source information which is always mapped to individual dimensions (i.e. each field type in the transaction-source is a dimension and each unique value of that field is a unique row for that dimension). In a pivot table the dimensions answer the question “what is the audience” about whom the analysis is being done.
Event-Timeline which is always mapped to individual metrics (i.e. the count of each event type appearing on the timeline is a value for the metric, as is the sum of the dollars attached to the event). In a pivot table the metrics answer the question “how many people did this, and how much money did they make/cost us”
   A single transaction is comprised of one (and only one) transaction-source record and 1-to-N events records.

### Event-Timeline

Each event is recoded a little farther in the timeline than the previous event (i.e. the [event(N).timestamp]>[event(N−1).timestamp]. At design time the Event is defined as follows

| | |
|---|---|
| ID | Primary key |
| Event TAG | Unique (alpha-numeric) identifier of the event type definition |
| | (which is the same across all environments, and should not |
| | be confused with the primary key that can change between |
| | DB instances or name which is user maintained and can |
| | also change. |
| Name | User Defined |
| TYPE | Unique tag defining an event category (e.g. “conversion” or |
| | “step 1”) which serves to aggregate like events in the DWH |
| | or to control fire-events in run-time |
| Funnel ID | Pointer to a funnel definition for which this event is a part of |
| | (optional and absent for system defined events such as |
| | impression, click, etc . . . ) |

Each event is comprised of both required and optional data. The required data for the event is

| | |
|---|---|
| Transaction | Pointer to the Transaction-Source Record |
| ID | |
| Event TAG | Unique (alpha-numeric) identifier of the event type |
| Time Stamp | |
| Duration | (May be null or unknown). If known measures the time to |
| | load for this particular event (e.g. ad-load-time or page- |
| | load-time). In the DWH the duration value is actually |
| | translated to a dimension (which is the one exception to the |
| | mapping discussed above) |

The optional data for the event is entirely composed of financial data. All of the fields are extremely unlikely to appear on a single event. We will discuss an example of this later. The optional data fields are (starting from the order in which they need to be calculated). The fields marked with an * are asserted facts (and are not subject to calculation)

| | |
|---|---|
| Requested-Revenue* | This is the dynamic CPx (e.g. dCPA) value |
| | reported by the advertiser for a monetization event |
| | such a conversion. This is an advanced function, |
| | because there are relatively few advertisers that |
| | have the sophistication to calculate user-values |
| | dynamically and pass back a dCPA. However, if |
| | present, this field must be validated before it can |
| | be used as revenue (we need to have rules |
| | specifying min and max values) to guard against |
| | the advertiser accidentally (or on purpose) breaking |
| | our serving decisions (e.g. by reporting $0 or by |
| | reporting $10000 per event). |
| Bid-Cost* | If using RTB, this is the amount we bid in order to |
| | win this impression. It is not necessarily the same |
| | as the cost field which may be based on 2^{nd} bid |
| | auction system. |
| Revenue (uncapped, | This is the calculated 1^{st} party revenue for this |
| not restated) | event. If “requested-revenue” is present, these two |
| | fields will often correspond unless the requested- |
| | revenue is in error |
| Underwritten- | This field is calculated from a yield-cube lookup. It |
| Revenue | substitutes a revenue forecast on an earlier event |
| | for actual revenue which can be known only on a |
| | later event (e.g. revenue from returning user, |
| | underwritten-revenue on a conversion). By |
| | definition, it makes no sense to have Revenue and |
| | Underwritten-Revenue on the same event. |
| Cost-Basis | This field has two separate calculations. If |
| | necessary, the first calculation is the same as |
| | underwritten-revenue for this event (may be |
| | absent, and then revenue is used as an input). The |
| | second is the application of a discount to the |
| | revenue number in order to take additional margin |
| | on the advertiser side. The margin discount is |
| | calculated by the “Advertiser Margin Management” |
| | demon and therefore needs to be reported on |
| | separately from cost |
| Cost | This is the 1^{st} party cost as applied to the specific |
| | slot (can be asserted as static CPM, can be |
| | dynamic CPM of the bid or can be applied as |
| | PAYOUT percent of the cost-basis). In the payout- |
| | percent case this is based on a discount calculated |
| | by the “Publisher Margin Management” demon. |

Below is are several example timelines with the fields specified

| Event | Field | Value |
|---|---|---|
| Bid Opportunity | Bid-Cost | $1.00 |
| Ad-Call/Impression | Cost | $0.80 |
| Click | | |
| Conversion | Underwritten-Revenue | $2.00 |
| Returning User | Revenue | $6.00 |
| Ad-Call/Impression | | |
| Click | | |
| Conversion | Revenue | $2.00 |
| | Cost-Basis | $1.50 |
| | Cost | $1.20 |
| Ad-Call/Impression | | |
| Click | Underwritten-Revenue | $1.50 |
| | Cost-Basis | $1.50 |
| | Cost | $1.20 |
| Conversion | Revenue | $10.00 |
| Ad-Call/Impression | | |
| Click | | |
| Install | Underwritten-Revenue | $1.50 |
| | Cost-Basis | $1.50 |
| | Cost | $1.20 |
| Rev-Share Event[1] | Revenue | $1.00 |
| Rev-Share Event[2] | Revenue | $2.00 |
| Rev-Share Event[3] | Revenue | $0.50 |
| Rev-Share Event[4] | Revenue | $1.10 |
| Rev-Share Event[5] | Revenue | $0.20 |
| Rev-Share Event[6] | Revenue | $0.15 |

### Transaction-Source

As mentioned earlier, the function of the source record for the transaction is to map onto reportable dimensions. The source record is created with each new transaction. As data is recorded into the source record, it is not modifiable. However, the source record can grow over time, and new data can be appended to it. It is the job of ETL to summarize (union) all of the appends made to the source record to create a single master source record for the transaction. A simple (oversimplified) example below illustrates how the source record can grow over the event-timeline, as new facts become known

| | | | | |
|---|---|---|---|---|
| Time: | 00:00 | 00:01 | 00:30 | 02:40 |
| Event: | Bid | Impression | Click | Conversion |
| Source: | Publisher | Publisher | Publisher | Publisher |
| | Slot | Slot | Slot | Slot |
| | Frequency | Frequency | Frequency | Frequency |
| | Country | Country | Country | Country |
| | | Slot Rotation | Slot Rotation | Slot Rotation |
| | | Algorithm | Algorithm | Algorithm |
| | | Campaign | Campaign | Campaign |
| | | Ad Rotation | Ad Rotation | Ad Rotation |
| | | Ad | Ad | Ad |
| | | | RP Domain | RP Domain |
| | | | RP Rotation | RP Rotation |
| | | | RP | RP |
| | | | | Subid-City: Seattle |
| | | | | Subid-ZIP: 91870 |
| | | | | Subid-Customer: 123 |

As discussed, the source record should tell us “what is the audience” the rest of the analysis is talking about. The audience can be thought of as having distinct components
What inventory did we buy
What do we know about this particular consumer/at this time
What placements did we show (process)
Why did we show the placements that we did
What additional information did we learn about the consumer (sub-ids)
   Examples of fields for each of these questions are below
What inventory did we buy
   Transaction Timestamp
   IP Address
   Geography
   Publisher/Site/Slot
   Slot Frequency
   Ad Size
   Keyword (if buying on search) and Keyword Match Type (exact/broad) and raw Query
   Referrer
   Additional Parameters passed to us (e.g. Publisher Transaction ID to be returned)
What do we know about this particular consumer/at this time
   Device
   Browser/OS
   Connection Type/Speed
   Include/Exclude Cookies
   Other targeting Cookies
   Gender
   Age Range
What placements did we show (process)
   Slot
   Slot Rotation+Version+Position
   Algo
   Campaign (Advertiser, Product, Category)
   Ad Rotation+Version+Position
   Ad
   RP Rotation+Version+Position
   RP
   Exit Action
   All of the Attributes of all of the placements (no need to enumerate here)
Why did we show the placements that we did
   Optimizer Rule
   Learning or Scaled
   Number of Campaigns in Auction
   Expected RPM
   Winner RPM
   Etc (see current system)
What additional information did we learn about the consumer (sub-ids)
   Customer ID
   Reportable SUB-IDs (city, mobile carrier, zip, etc.)

While the invention has been discussed using as an example websites, the invention is not so limited and may be used in other media and formats. For example in interactive television.

Thus a method and apparatus for landing page optimization have been described.

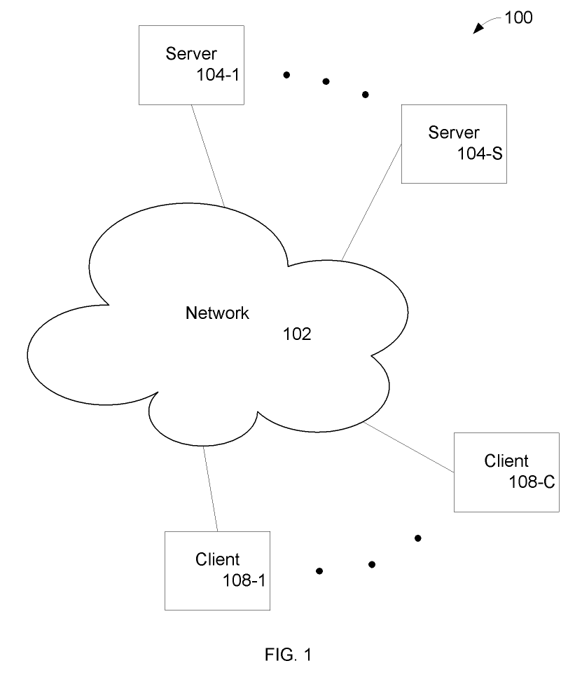

FIG. 1 illustrates a network environment 100 from which the techniques described may be controlled. The network environment 100 has a network 102 that connects S servers 104-1 through 104-S, and C clients 108-1 through 108-C. More details are described below.

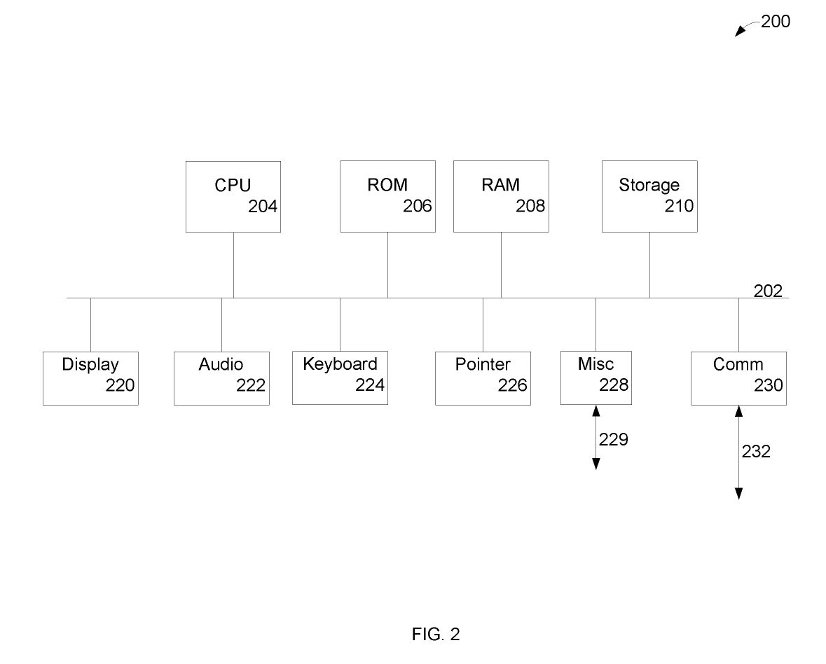

FIG. 2 is a block diagram of a computer system 200 which some embodiments of the invention may employ parts of and which may be representative of use in any of the clients and/or servers shown in FIG. 1, as well as, devices, clients, and servers in other Figures. More details are described below.

Referring back to FIG. 1, FIG. 1 illustrates a network environment 100 in which the techniques described may be controlled. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be controlled by essentially any type of communicating means or device whether local or remote, such as a LAN, a WAN, a system bus, etc. For example, a network connection which communicates via for example wireless may control an embodiment of the invention having a wireless communications device. Thus, the invention may find application at both the S servers 104-1 through 104-S, and C clients 108-1 through 108-C.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio 222, keyboard 224, pointer 226, miscellaneous input/output (I/O) devices 228 having a link 229, and communications 230 having a port 232. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, a liquid crystal display (LCD). Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform a useful action or produce a useful result. Such useful actions/results may be presented to a user in various ways, for example, on a display, producing an audible tone, mechanical movement of a surface, etc.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals which upon reception causes movement in matter (e.g. electrons, atoms, etc.) (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

As used in this description, “substantially” or “substantially equal” or similar phrases are used to indicate that the items are very close or similar. Since two physical entities can never be exactly equal, a phrase such as ““substantially equal” is used to indicate that they are for all practical purposes equal.

It is to be understood that in any one or more embodiments of the invention where alternative approaches or techniques are discussed that any and all such combinations as my be possible are hereby disclosed. For example, if there are five techniques discussed that are all possible, then denoting each technique as follows: A, B, C, D, E, each technique may be either present or not present with every other technique, thus yielding 2̂5 or 32 combinations, in binary order ranging from not A and not B and not C and not D and not E to A and B and C and D and E. Applicant(s) hereby claims all such possible combinations. Applicant(s) hereby submit that the foregoing combinations comply with applicable EP (European Patent) standards. No preference is given any combination.

Thus a method and apparatus for landing page optimization have been described.

What is claimed is:

1. A method for landing page optimization comprising:
defining a cube to have a plurality of dimensions related to a user click through on a campaign;
generating a set of vectors having a plurality of said dimensions ordered in a sequence from a first dimension to drop to a last dimension to drop;
defining a significance test for data;
retrieving from a data warehouse historical data for landing pages for said campaign;
running said set of vectors with said respective historical data through said significance test for data; and
when significant then placing said retrieved data and said vector into a cell in said cube for said campaign.

2. The method of claim 1 further comprising:
generating a predicted revenue based on said user click through; and
presenting to said user a highest predicted revenue landing page from a plurality of landing pages for said campaign.

3. The method of claim 1 wherein said generating a set of vectors further comprises:
generating said set of vectors by including slot frequency for said user.

4. A method for landing page optimization comprising:
defining a cube to have a plurality of dimensions excepting a time dimension;
defining a plurality of cells within said cube wherein each cell has a plurality of campaigns;
generating a set of vectors having a plurality of said dimensions ordered in a sequence from a first dimension to drop to a last dimension to drop for each of said campaigns;
defining a significance test for data;
retrieving from a data warehouse historical data for said campaigns;
running said set of vectors with said respective historical data through said significance test for data for each of said campaigns for all possible user click through points and determining in each case a highest yielding revenue landing page; and
presenting to said user said highest yielding revenue landing page based on which said click through point was selected by said user.

5. The method of claim 4 further comprising:
re-running said significant test for data based on said retrieved results combined with said user selected click through point.

6. An apparatus for landing page optimization comprising:
a machine having a database, said database having an input, and an output;
a landing page prediction engine having an input, an output, and a significance input, wherein said prediction engine input is coupled to said database output;
a significance test having an output, said output coupled to said landing page prediction engine significance input;
a landing page presenter having an input and an output, said landing page presenter input coupled to said prediction engine output, and said landing page presenter output coupled to said database input, and presented to said user.

7. The apparatus of claim 6 wherein said database is a star schema database, and presented to said user is a new web page.
